(19) United States
(12) Patent Application Publication
(10) Pub. No.: US 2026/0284536 A1
(43) Pub. Date: Sep. 24, 2026

(54) ONE OR MORE NON-TRANSITORY COMPUTER-READABLE STORAGE MEDIA, GAME SYSTEM, GAME APPARATUS AND COMPUTER-IMPLEMENTED METHOD

(71) Applicant: Nintendo Co., Ltd., Kyoto (JP)

(72) Inventors: Masahiro SAKURAI, Tokyo (JP); Masanobu TOMOE, Tokyo (JP)

(21) Appl. No.: 19/554,093

(22) Filed: Mar. 2, 2026

(30) Foreign Application Priority Data
Mar. 24, 2025 (JP) 2025-048949

(51) Int. Cl. A63F 13/69; A63F 13/79

(52) U.S. Cl. CPC A63F 13/69; A63F 13/79; A63F 2300/5553; A63F 2300/8023

(57) ABSTRACT

It is determined whether a predetermined condition that is satisfied when no walking character exists at a position close to an empty machine is satisfied. If the predetermined condition is satisfied, the empty machine is brought into a state in which a walking character cannot board the empty machine. If the predetermined condition is not satisfied, the empty machine is not brought into a state in which a walking character cannot board the empty machine.

### CROSS REFERENCE TO RELATED APPLICATION

This application claims priority to Japanese Patent Application No. 2025-48949 filed on Mar. 24, 2025, the entire contents of which are incorporated herein by reference.

### FIELD

The present disclosure relates to information processing.

### BACKGROUND AND SUMMARY

Conventionally, there have been games in which a player character is caused to board a rideable object to play a competitive game.

However, there has been room for improvement in changing the state of the rideable object.

### Configuration examples will be shown below.

### Configuration Example 1

A configuration example 1 is directed to one or more non-transitory computer-readable storage media having stored therein instructions that, when executed, cause one or more processors to perform operations including:

executing a first multiplayer game in which a plurality of participating characters participate; and

in the first multiplayer game,

if a first condition that is not satisfied when a positional relationship between a first participating character and a rideable object not being ridden by any of the plurality of participating characters among a plurality of rideable objects placed in a first game stage is a first positional relationship and that is satisfied when the positional relationship is a second positional relationship closer than the first positional relationship is satisfied, causing the first participating character to board the rideable object,

causing the first participating character riding a rideable object to transition to a state of not riding the rideable object, in response to at least a first instruction based on an operation input,

if the first participating character is riding a rideable object, performing control of the first participating character, including at least movement in the first game stage, in response to a second instruction based on an operation input, based on a first in‑game parameter based on the rideable object being ridden by the first participating character,

if at least the first participating character is riding a rideable object and a second condition that is not satisfied when a positional relationship between the first participating character and an in-game item placed in the first game stage is a third positional relationship and that is satisfied when the positional relationship is a fourth positional relationship closer than the third positional relationship is satisfied, causing the first participating character to acquire the in-game item,

determining the first in‑game parameter corresponding to the rideable object being ridden by the first participating character, further based on the in-game item acquired by the first participating character, and

in a first scene, if a third instruction to cause a second participating character to attack a rideable object not being ridden by any of the plurality of participating characters is performed,

determining whether or not a third condition is satisfied, the third condition being satisfied when the first participating character not riding a rideable object does not exist at a position that satisfies the first condition with reference to a position of the rideable object,

if the third condition is satisfied, setting a state of the rideable object to a state in which at least the first participating character cannot board the rideable object, and

if the third condition is not satisfied, not setting the state of the rideable object to a state in which the first participating character cannot board the rideable object.

### Configuration Example 2

In a configuration example 2 based on, for example, the above configuration example 1, the operations further include:

in response to a fourth instruction based on an operation input, sequentially executing the first multiplayer game and a second multiplayer game that is executed after end of the first multiplayer game; and

in the second multiplayer game,

causing the first participating character to board a rideable object of the same type as a type of rideable object ridden at the end of the first multiplayer game among a plurality of types of the rideable objects,

based on the type of a rideable object being ridden by the first participating character and the in-game item acquired by the first participating character at the end of the first multiplayer game, determining a second in-game parameter corresponding to the rideable object,

performing control of the first participating character riding the rideable object, including movement in a second game stage, in response to a fifth instruction based on an operation input, based on the second in-game parameter,

causing the plurality of participating characters to compete with each other, and

determining a win/loss or ranking of the plurality of participating characters in accordance with a result of the competition.

### Configuration Example 3

In a configuration example 3 based on, for example, the above configuration example 1, the operations further include, when the third instruction is performed with respect to the rideable object,

if the third condition is satisfied, updating a durability parameter indicating durability of the rideable object, by a first change amount, and

if the third condition is not satisfied, not updating the durability parameter or updating the durability parameter by a second change amount smaller than the first change amount, and

the first scene is a scene in which the durability parameter reaches a specified value when the third condition is satisfied.

### Configuration Example 4

In a configuration example 4 based on, for example, the above configuration example 3, the operations further include:

if the third instruction is performed with respect to a rideable object being ridden by the first participating character, updating the durability parameter corresponding to the rideable object; and

if the durability parameter corresponding to the rideable object being ridden by the first participating character reaches the specified value, causing the first participating character to transition to a state of not riding the rideable object, and setting a state of the rideable object to a state in which at least the first participating character cannot board the rideable object.

### Configuration Example 5

In a configuration example 5 based on, for example, the above configuration example 1, the operations further include, when the third instruction is performed with respect to the rideable object,

if the third condition is satisfied, moving the position of the rideable object, and

if the third condition is not satisfied, not moving the position of the rideable object.

### Configuration Example 6

In a configuration example 6 based on, for example, the above configuration example 5, the operations further include setting a state of a rideable object that has not been ridden by any participating characters for a first period, to a state in which no participating character can board the rideable object.

### Configuration Example 7

In a configuration example 7 based on, for example, the above configuration example 2, the third condition is further satisfied in a period after a second period has elapsed from start of the first multiplayer game.

### Configuration Example 8

In a configuration example 8 based on, for example, the above configuration example 1, the third condition is not satisfied when a number of the in-game items acquired by the first participating character is smaller than a number of the in-game items acquired by another participating character.

### Configuration Example 9

In a configuration example 9 based on, for example, the above configuration example 1, the third condition is satisfied with a first probability, and the first probability becomes lower as a number of the in-game items acquired by the first participating character becomes smaller relative to a number of the in-game items acquired by another participating character.

### Configuration Example 10

In a configuration example 10 based on, for example, the above configuration example 1, the operations further include, if a positional relationship between a first rideable object not being ridden by any of the plurality of participating characters and the first participating character riding a second rideable object satisfies the first condition, causing the first participating character to board the first rideable object without causing the first participating character to transition to a state of not riding any of the first rideable object and the second rideable object.

### Configuration Example 11

In a configuration example 11 based on, for example, any one of the above configuration examples 1 to 10, the operations further include, if the positional relationship between the first participating character and the in-game item satisfies the second condition and the first participating character is not riding a rideable object, not causing the first participating character to acquire the in-game item.

### Configuration Example 12

In a configuration example 12 based on, for example, any one of the above configuration examples 1 to 10, the operations further include, in movement control of the first participating character in the first game stage, moving the first participating character riding a rideable object, at a higher movement speed than when the first participating character is not riding a rideable object.

### Configuration Example 13

In a configuration example 13 based on, for example, any one of the above configuration example 1 or 10, the operations further include, if the first participating character is riding a rideable object and the third instruction based on an operation input is performed with respect to a stage object placed in the first game stage, placing at least the in-game item acquirable by the first participating character, in the first game stage.

### Configuration Example 14

In a configuration example 14 based on, for example, the above configuration example 13, the stage object includes a rideable object not being ridden by any of the plurality of participating characters.

### Configuration Example 15

In a configuration example 15 based on, for example, any one of the above configuration examples 1 to 10, at least a part of the in-game items is placed at a position in the first game stage to which the participating character not riding a rideable object cannot move.

Each configuration example described above may be read as a configuration example of a game system, a game apparatus, or a computer-implemented method.

### BRIEF DESCRIPTION OF THE DRAWINGS

FIG. 1 shows a non-limiting example of a state where a left controller 3 and a right controller 4 are attached to a main body apparatus 2;

FIG. 2 is a block diagram showing a non-limiting example of the internal configuration of the main body apparatus 2;

FIG. 3 is a block diagram showing a non-limiting example of the internal configurations of the main body apparatus 2, the left controller 3, and the right controller 4;

FIG. 4 illustrates a non-limiting example of a game screen;

FIG. 5 illustrates a non-limiting example of a game screen;

FIG. 6 illustrates a non-limiting example of a game screen;

FIG. 7 illustrates a non-limiting example of actual performance values in a state where a player character is riding a machine;

FIG. 8 illustrates a non-limiting example of a game screen;

FIG. 9 illustrates a non-limiting example of a game screen;

FIG. 10 illustrates a non-limiting example of a game screen;

FIG. 11 illustrates a non-limiting example of a game screen;

FIG. 12 illustrates a non-limiting example of a game screen;

FIG. 13 illustrates a non-limiting example of values related to the number of acquired items;

FIG. 14 illustrates a non-limiting example of a game screen;

FIG. 15 illustrates a non-limiting example of a game screen;

FIG. 16 illustrates a non-limiting example of various data stored in a DRAM 85;

FIG. 17 is a non-limiting example of a flowchart of game processing;

FIG. 18 is a non-limiting example of a flowchart of game processing;

FIG. 19 is a non-limiting example of a flowchart of game processing;

FIG. 20 is a non-limiting example of a flowchart of game processing;

FIG. 21 is a non-limiting example of a flowchart of game processing;

FIG. 22 is a non-limiting example of a flowchart of game processing;

FIG. 23 is a non-limiting example of a flowchart of game processing;

FIG. 24 is a non-limiting example of a flowchart of game processing;

FIG. 25 is a non-limiting example of a flowchart of game processing; and

FIG. 26 is a non-limiting example of a flowchart of game processing.

### DETAILED DESCRIPTION OF NON-LIMITING EXAMPLE EMBODIMENTS

Hereinafter, an exemplary embodiment will be described.

### Hardware configuration of information processing system

Hereinafter, an information processing system (game system, game apparatus) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment will be described, and then, the control of the game system 1 according to the exemplary embodiment will be described.

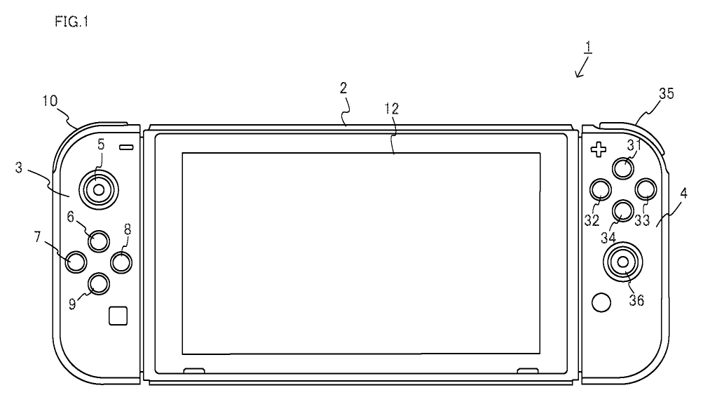

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes in the game system 1. The main body apparatus 2 includes a display 12. Each of the left controller 3 and the right controller 4 is an apparatus including operation sections with which a user provides inputs.

In addition, the main body apparatus 2 includes a speaker, and a sound such as a sound effect is outputted from the speaker.

Further, the main body apparatus 2 includes a left terminal for the main body apparatus 2 to perform wired communication with the left controller 3, and a right terminal for the main body apparatus 2 to perform wired communication with the right controller 4.

Further, the main body apparatus 2 includes a slot. The slot is provided at an upper side surface of a housing of the main body apparatus 2. The slot is so shaped as to allow a predetermined type of storage medium to be attached to the slot. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2.

The left controller 3 and the right controller 4 each include various operation buttons and the like. For example, the left controller 3 includes buttons 6 to 10 and a left stick 5, which is a directional input device. For example, the right controller 4 includes buttons 31 to 35 and a right stick 36, which is a directional input device. The various operation buttons and the like are used to give instructions depending on various programs (e.g., an OS program and an application program) executed by the main body apparatus 2.

In addition, the left controller 3 and the right controller 4 each include a terminal for performing wired communication with the main body apparatus 2.

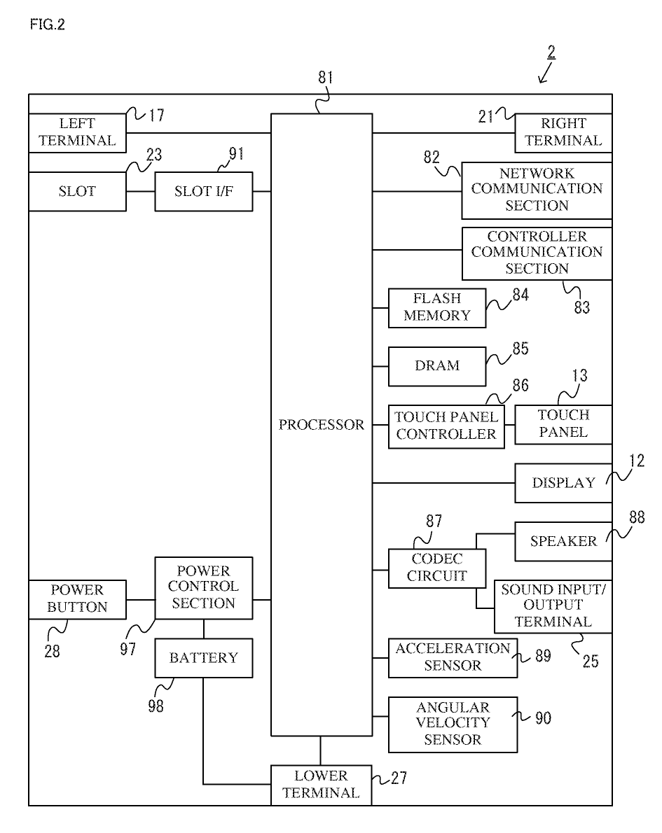

FIG. 2 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed of a plurality of processors or cores, typically, a plurality of CPUs (Central Processing Units) or cores, or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing. The above information processing program includes computer-executable instructions. In the exemplary embodiment, the term “processor” may include at least a CPU, a GPU, an ASIC (Application Specific Integrated Circuit), an FPGA (Field Programmable Gate Array), and the like. In addition, in the exemplary embodiment, the term “computer” refers to one that includes at least one processor, as an example, and may further include a storage section such as at least one memory.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. As each of these memories, a plurality of memories may be provided.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (for example, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

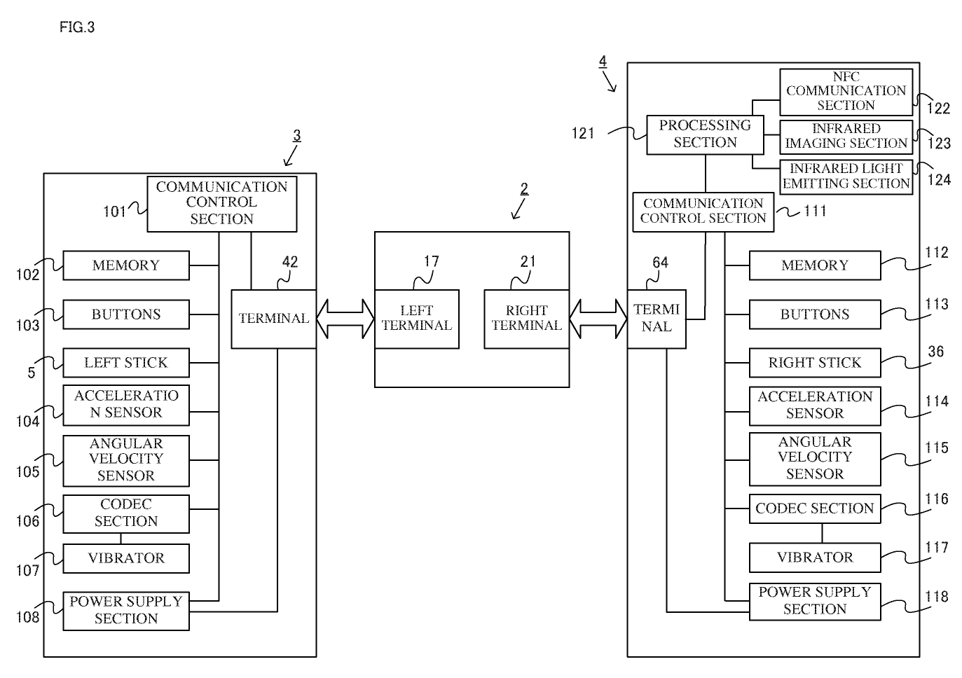

FIG. 3 is a block diagram showing examples of the internal configurations of the main body apparatus 2, the left controller 3, and the right controller 4. The details of the internal configuration of the main body apparatus 2 are shown in FIG. 2 and therefore are omitted in FIG. 3.

The left controller 3 includes a communication control section 101, which communicates with the main body apparatus 2. As shown in FIG. 3, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (6 to 10 in FIG. 1). Further, the left controller 3 includes the left stick 5. Each of the buttons 103 and the left stick 5 outputs information regarding an operation performed on itself to the communication control section 101 repeatedly at appropriate timings.

The left controller 3 includes inertial sensors. Specifically, the left controller 3 includes an acceleration sensor 104 and an angular velocity sensor 105.

The communication control section 101 acquires information regarding an input (specifically, information regarding an operation or the detection result of the sensor) from each of input sections (specifically, the buttons 103, the left stick 5, and the sensors 104 and 105). The communication control section 101 transmits operation data including the acquired information (or information obtained by performing predetermined processing on the acquired information) to the main body apparatus 2. The operation data is transmitted repeatedly, once every predetermined time.

The above operation data is transmitted to the main body apparatus 2, whereby the main body apparatus 2 can obtain inputs provided to the left controller 3. That is, the main body apparatus 2 can determine operations on the buttons 103 and the left stick 5 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

As shown in FIG. 3, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 (31 to 35 in FIG. 1), the right stick 36 and inertial sensors (an acceleration sensor 114 and an angular velocity sensor 115). These input sections have functions similar to those of the input sections of the left controller 3 and operate similarly to the input sections of the left controller 3.

The main body apparatus 2 can also communicate with controllers other than the left controller 3 and the right controller 4 described above (another left controller 3 and another right controller 4), and the processor 81 can perform game processing, etc., based on operation data received from many controllers. That is, many controllers can be connected to the main body apparatus 2, and a multiplayer game or the like can be played by a plurality of users using the one main body apparatus 2. In addition, the main body apparatus 2 can also communicate with one or more other main body apparatuses 2, and a multiplayer game or the like can be played by a plurality of users. Further, a plurality of users can play a multiplayer game or the like in a mode in which the above-described modes are combined. In the following, a case where a multiplayer game is played by players using respective main body apparatuses 2 will be described as an example.

### Game assumed in exemplary embodiment

The game assumed in the exemplary embodiment is, as an example, a multiplayer game in which 2 to 16 players can play simultaneously, and in which a first game and a second game are sequentially executed in response to an instruction to start a competitive game. The second game does not necessarily need to be executed immediately after the first game, and another game may be executed between the first game and the second game. Further, the first game and the second game may be switched seamlessly.

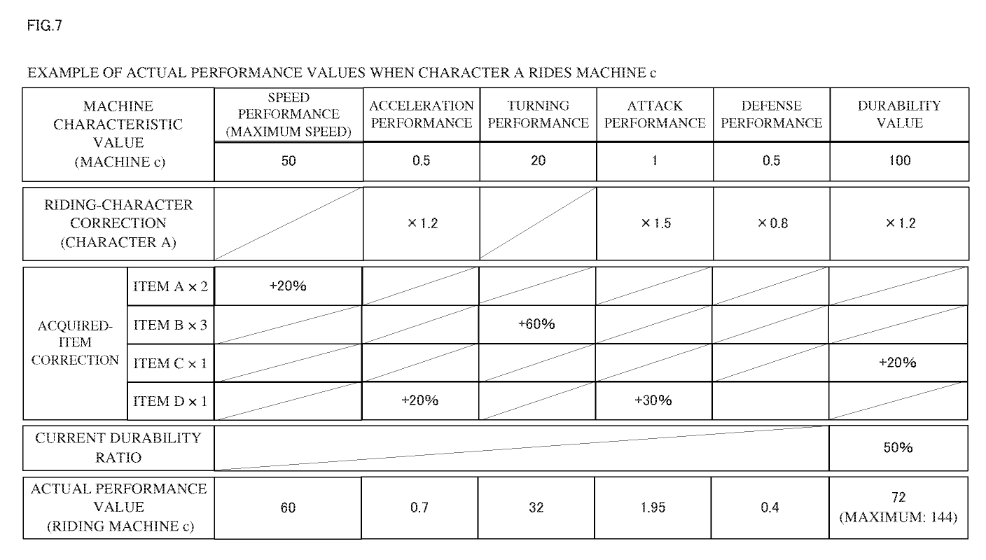

The first game is, for example, a game that ends upon the elapse of a predetermined time (for example, 5 minutes). In the game stage of the first game, for example, each player moves a player character (sometimes simply referred to as “character”) riding a machine (rideable object for the player). In the first game, each player moves the character riding the machine and causes the character to acquire items placed in the game stage, thereby improving actual performance values in a state where the character is riding the machine (parameter values, in a character-riding state, of “speed performance”, “acceleration performance”, “turning performance”, “attack performance”, “defense performance”, and “durability”, which will be described later with reference to FIG. 7 and which are sometimes simply referred to as “actual performance values”). Further, there are a plurality of types of machines, and “machine characteristic values”, which will be described later, differ depending on the type of machine. The actual performance values may include other types of performance such as flight performance for flying in the air. In addition, each machine may have different characteristics. For example, when a character boards a specific machine type, a predetermined action corresponding to that machine type may be enabled. Further, for example, the first game may end when the total number of items acquired by all participating players reaches a predetermined number (or a predetermined proportion of the total number of items), or when a specific item is acquired by a player, or the first game may end in response to an end instruction performed by a player.

Further, in the first game, each player can operate their own player character (sometimes referred to as “own character”) to cause the player character to board a machine placed in the game stage, to switch to another machine, or to attack another player character riding a machine (sometimes referred to as “other character”) to destroy that machine. Acquired items are associated with the character. Thus, when the character switches machines, the actual performance values after the switch are determined in accordance with the acquired items. Further, as will be described later with reference to FIG. 7, the type of character also affects the actual performance values.

The second game is a game that is started in a state where each character is riding the machine that had been ridden by the character at the end of the first game (or a machine of the same type), and during the second game, each character cannot switch machines. Further, at the start of the second game, the actual performance values at the end of the first game are carried over. There are a plurality of types of second games (four types in the exemplary embodiment), and the actual performance values that are important differ depending on the type of the second game to be played. For example, when participating in a race-type competitive game among the second games, having, for example, a high speed performance is advantageous. For example, when participating in a battle-type competitive game among the second games, having, for example, a high attack performance is advantageous. The result of the second game (for example, a win/loss or a ranking) is the result of this competitive game. The game stage of the first game and the game stage of the second game may be the same.

Thus, each player acquires items and switches machines in the first game so as to build desired actual performance values in order to be able to play advantageously in the second game in which the player participates. The characters participating in this competitive game may include non-player characters operated by the processor 81.

### Outline of game processing of exemplary embodiment

First, at the start (or before the start) of the competitive game of the exemplary embodiment, each player selects their own character from among a plurality of characters. There is only one type of the first game, and all characters participating in this competitive game participate in the first game. The second games include, for example, a first race game in which characters hardly attack each other and which has many straight sections (a second game in which “speed performance” is particularly important), a second race game in which characters hardly attack each other and which has few straight sections (a second game in which “acceleration performance” and “turning performance” are particularly important), a first battle game in which characters attack each other and defeat opponents in a complicated maze (a second game in which “attack performance”, “defense performance”, and “durability” are particularly important), and a second battle game in which characters attack each other and defeat opponents on a plain with few obstacles (a second game in which all performances are important). Further, in the exemplary embodiment, after the end of the first game, each player selects the type of the second game to participate in (sometimes referred to as “competitive format”). Before the end of the first game, each player may select the type of the second game to participate in. Further, the number of types of second games may be only one. Alternatively, the number of types of second games may be two or three, or may be more than four.

### First game

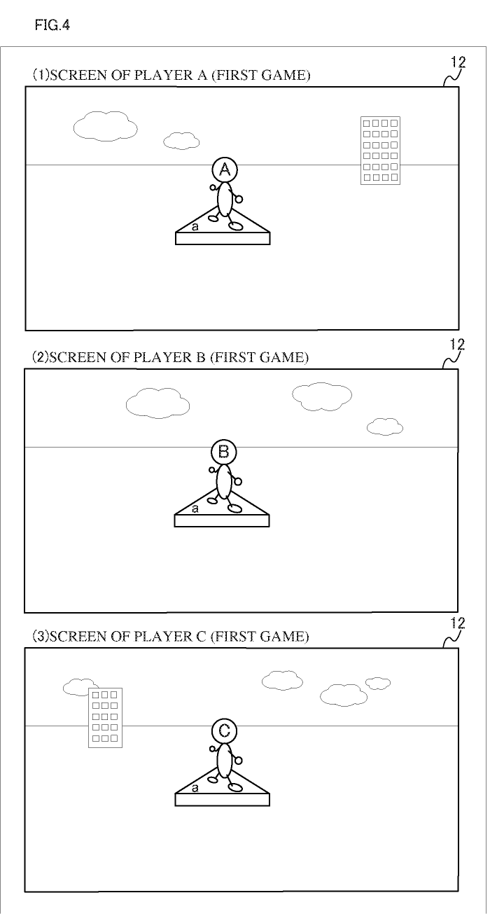

FIG. 4 illustrates an example of images displayed on the displays 12 of the players at the start of the first game. As shown in FIG. 4, when the first game is started, the own character riding one type of machine determined in advance in the game stage of the first game (in the exemplary embodiment, a machine a) is displayed on the display 12 of each player. That is, all characters ride the same type of machines a, and the first game starts. In FIG. 4(1) to (3), the display of a player A shows a character A (character operated by the player A) riding the machine a, the display of a player B shows a character B (character operated by the player B) riding the machine a, and the display of a player C shows a character C (character operated by the player C) riding the machine a.

In the first game, player characters can ride a large number of machines placed in the game stage (for example, 20 types of machines). As will be described later with reference to FIG. 7, “machine characteristic values” are preset for each machine, and the machine characteristic values are corrected in accordance with the type of the riding character and the items acquired by the riding character, thereby determining actual performance values. The machine a, which is ridden by each character at the start of the first game, has machine characteristic values that are set generally lower than those of other types of machines. Therefore, in the first game, each player plays by acquiring items and switching to other machines so as to gain an advantage in the second game.

In the first game, each player can operate the own character to move the own character in a state of riding a machine, and can also move the own character in a state where the own character is not riding a machine (that is, in an on-foot state). Further, in the first game, each character can move significantly faster in a state of riding a machine than in an on-foot state, and can go to locations that cannot be reached in an on-foot state.

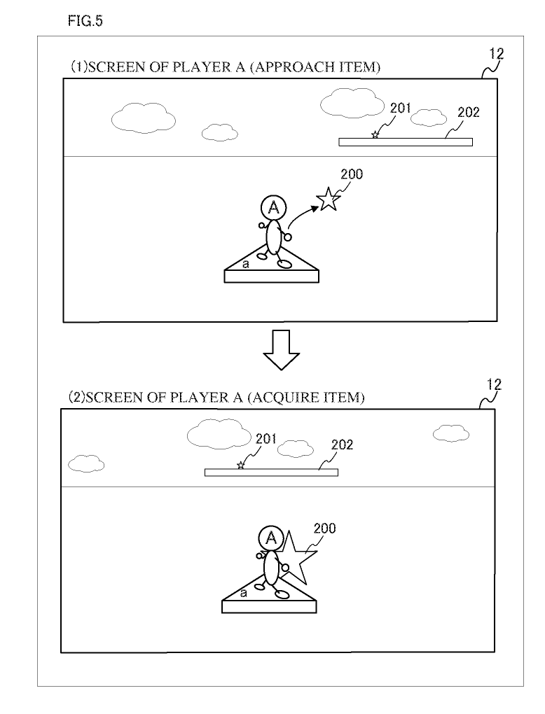

FIG. 5 illustrates a scene in which a character riding a machine acquires an item in the first game. In the first game, each character can acquire items in a state of riding a machine, but cannot acquire items in an on-foot state. When, in response to an operation performed by the player, the character moves toward an item in a state of riding the machine a shown in FIG. 5(1), and the character enters a predetermined range of the item (for example, within a range of 0.5 m in a virtual space) as shown in FIG. 5(2), the character acquires the item. In FIG. 5, an item 200 enters a predetermined range of a character A riding the machine a and is acquired. When an acquisition instruction (for example, an operation on a predetermined button) is performed by the player in a state where the character riding the machine is within a predetermined range of an item, the character may acquire the item. Further, when a hit determination (collision) occurs between a character riding a machine (or a machine ridden by a character) and an item, the item may be acquired. In another exemplary embodiment in which a character in an on-foot state can also acquire an item, a collision-detection range for a character riding a machine may be made larger than that for a character in an on-foot state.

An acquired item is deleted from the game stage and cannot be acquired by any character thereafter. The acquired item may be hidden only on the screen of the player who operates the character that has acquired the item, such that the item cannot be acquired again by that character, and may be displayed on the screens of the other players.

Items are placed at various positions on the stage of the first game, including positions to which a character riding a machine can move but a character in an on-foot state cannot move. In FIG. 5, an item 201 is placed on a floating island 202 to which a character in an on-foot state (sometimes referred to as “walking character”) cannot go.

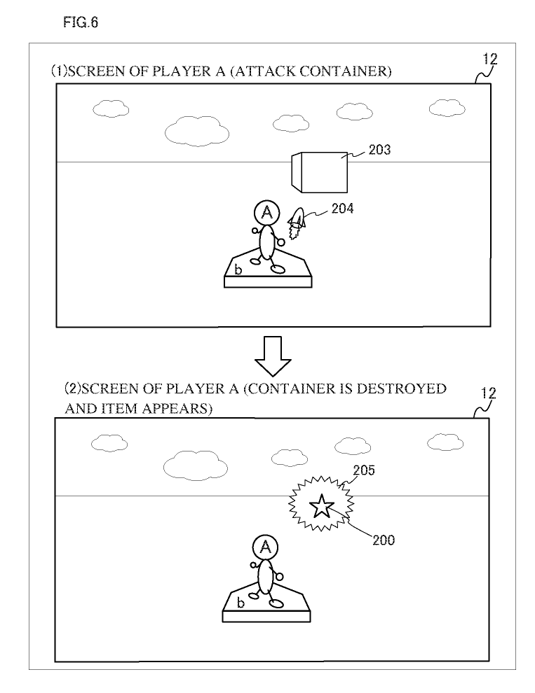

FIG. 6 illustrates an example of a scene in which, in the first game, a character riding a machine attacks and destroys a container. As shown in FIG. 6(1), in response to a predetermined operation (an attack instruction) performed by the player, a missile 204 is fired from a machine b ridden by the character A, toward a container 203. Then, if the missile 204 hits the container 203, an effect 205 indicating an explosion is displayed, the container 203 is destroyed, and an item 200 appears (see FIG. 6(2)). Then, a character riding a machine can acquire the appearing item 200. There are various types of attacks against a container, and the attack is not limited to this example. In addition, a walking character cannot acquire or use attack items such as the missile 204, and thus cannot attack and destroy a container and cannot cause an item to appear from the container.

FIG. 7 illustrates actual performance values in a state where a character is riding a machine. In FIG. 7, as an example, a case where the character A is riding a machine c is shown.

For each machine, “machine characteristic values” indicating characteristics of the machine itself are preset. The machine characteristic values are values inherent to the machine. The machine characteristic values include speed performance that defines a maximum speed, acceleration performance that defines acceleration force, turning performance that defines turning force, attack performance that defines attack power, defense performance that defines defense power, and durability that defines durability strength. The machine characteristic values are fixed values. In FIG. 7, as the characteristic values of the machine c, speed performance 50, acceleration performance 0.5, turning performance 20, attack performance 1, defense performance 0.5, and durability 100 are shown.

With respect to the machine characteristic values, correction corresponding to the type of the character riding the machine (riding-character correction) is performed. In FIG. 7, riding-character correction corresponding to the riding character A is performed. Specifically, as shown in FIG. 7, the acceleration performance is multiplied by 1.2, the attack performance is multiplied by 1.5, the defense performance is multiplied by 0.8, and the durability is multiplied by 1.2.

Thereafter, with respect to the machine characteristic values that have undergone the riding-character correction, correction corresponding to items acquired by the character riding the machine (acquired-item correction) is performed. In FIG. 7, the acquired-item correction corresponding to items acquired by the character A is performed. Specifically, as shown in FIG. 7, since two items A that each increase the speed performance by 10% have been acquired, the speed performance is increased by 20%; since three items B that each increase the turning performance by 20% have been acquired, the turning performance is increased by 60%; since one item C that increases the durability by 20% has been acquired, the durability is increased by 20%; and since one item D that increases the acceleration performance by 20% and increases the attack performance by 30% has been acquired, the acceleration performance is increased by 20% and the attack performance is increased by 30%.

As described above, by performing the riding-character correction and then performing the acquired-item correction on the machine characteristic values, the actual performance values are determined. In FIG. 7, as the actual performance values in a case where the character A is riding the machine c, the speed performance is 60, the acceleration performance is 0.7, the turning performance is 32, the attack performance is 1.95, and the defense performance is 0.4.

Here, the actual performance value of durability decreases due to being attacked or the like. In FIG. 7, the actual performance value of durability has decreased by 72 from a maximum value of 144, resulting in a value of 72. Further, as shown in FIG. 7, a ratio of the actual performance value of durability to the maximum value (current durability ratio) is calculated. In FIG. 7, a current durability ratio of 50% is calculated. Here, when another character rides a machine, the current durability ratio is carried over, and the actual performance value of durability is calculated based on the carried-over current durability ratio. For example, when the machine c in the state shown in FIG. 7 ridden by the character A is ridden by the character B for which riding-character correction for durability is 1.0 times and who has not acquired any items, the current durability ratio of 50% is carried over, and 50 is calculated as the actual performance value of durability.

When the actual performance value of durability becomes 0 (zero) (or less than 0), the machine is destroyed and no character can ride the machine. In addition, the higher the attack performance is, the more the actual performance value of durability of an attacked opponent can be reduced, and the higher the defense performance is, the more a decrease in the actual performance value of durability can be suppressed when being attacked.

In FIG. 7, decimal places of the actual performance values are not shown. The acquired-item correction may be performed on the machine characteristic values before the riding-character correction is performed. Further, in the riding-character correction and/or the acquired-item correction, instead of correcting the machine characteristic values by multiplying the machine characteristic values by predetermined factors, the correction may be performed by adding (or subtracting) constants. For example, there may be an item that adds 10 (a predetermined constant) to the speed performance value among the machine characteristic values each time the item is acquired. Further, there may be an item that decreases a machine characteristic value by multiplying the machine characteristic value by a predetermined factor.

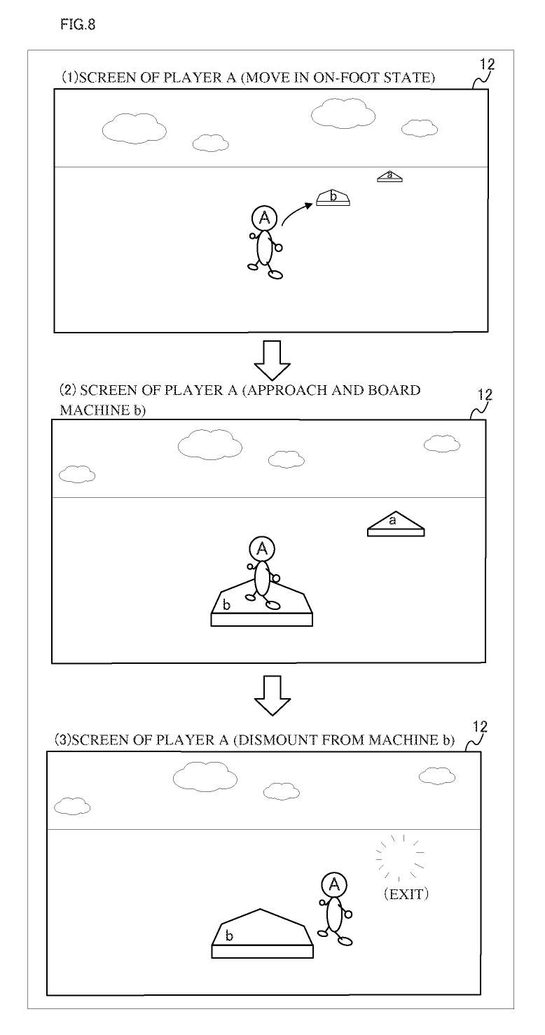

FIG. 8 illustrates scenes in which, in the first game in response to an operation performed by a player, a character is moved in an on-foot state, the character in the on-foot state is caused to board a machine that is not being ridden by any character (sometimes referred to as “empty machine”), and the character riding the machine is caused to dismount from the machine and transition to an on-foot state.

For example, when, in response to a predetermined operation performed by the player A, the character A moves on foot toward a machine b (see FIG. 8(1)) and comes into contact with the machine b, the character A boards the machine b (see FIG. 8(2)). That is, in response to a boarding instruction for the empty machine b, the character A is caused to board the empty machine b. The present disclosure is not limited to this example, and a character may board an empty machine when the distance between the empty machine and the character becomes equal to or less than a predetermined distance (for example, 5 m or 10 m). Alternatively, a character may board an empty machine when a predetermined button operation is performed in a state where the distance between the empty machine and the character is equal to or less than a predetermined distance (for example, 5 m or 10 m). Still alternatively, a character may board an empty machine when a predetermined button operation is performed in a state where the character is located within a predetermined area defined with reference to the empty machine (for example, a circular area centered on the empty machine, or a donut-shaped area centered on the center of the empty machine).

Further, for example, in response to a predetermined operation (for example, a predetermined button operation) performed by the player A, the character A dismounts from the machine b and transitions to an on-foot state (see FIG. 8(3)).

Further, in the first game, a machine that has not been ridden by any character for a predetermined time (for example, 2 minutes) exits the stage and is deleted therefrom. In FIG. 8, the machine a exits the stage and is deleted therefrom.

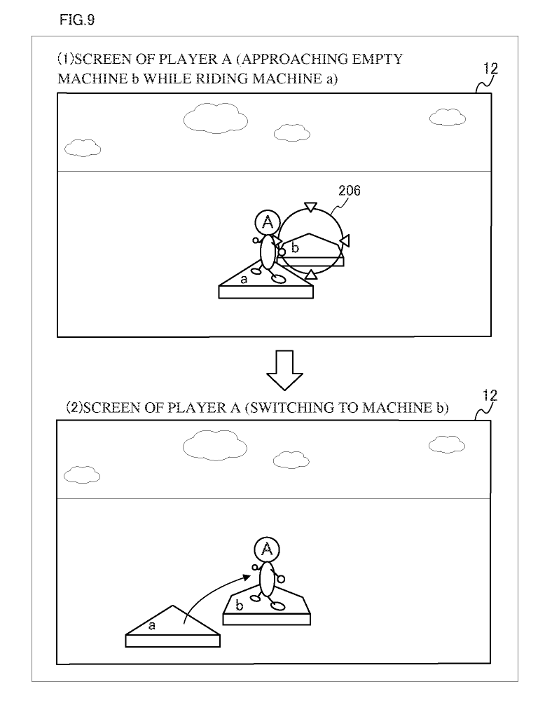

FIG. 9 illustrates a scene in which, in the first game, a character riding a machine switches to another empty machine without transitioning to an on-foot state. In the first game, each character riding a machine can directly switch to an empty machine without transitioning to an on-foot state. For example, when, in response to a movement operation performed by the player, the character A riding the machine a moves toward the empty machine b, and the empty machine b enters a predetermined range of the character A (for example, 5 m), a lock-on cursor 206 is displayed (see FIG. 9(1)). While the lock-on cursor 206 is displayed, in accordance with the machine a coming into contact with the machine b in response to a predetermined operation performed by the player A (for example, an operation for moving the machine a while pressing a predetermined button for one second or longer), the character A jumps from the machine a to the machine b to switch to the machine b (see FIG. 9(2)). In this case, the machine a that had been ridden by the character A is placed in the stage as an empty machine (see FIG. 9(2)).

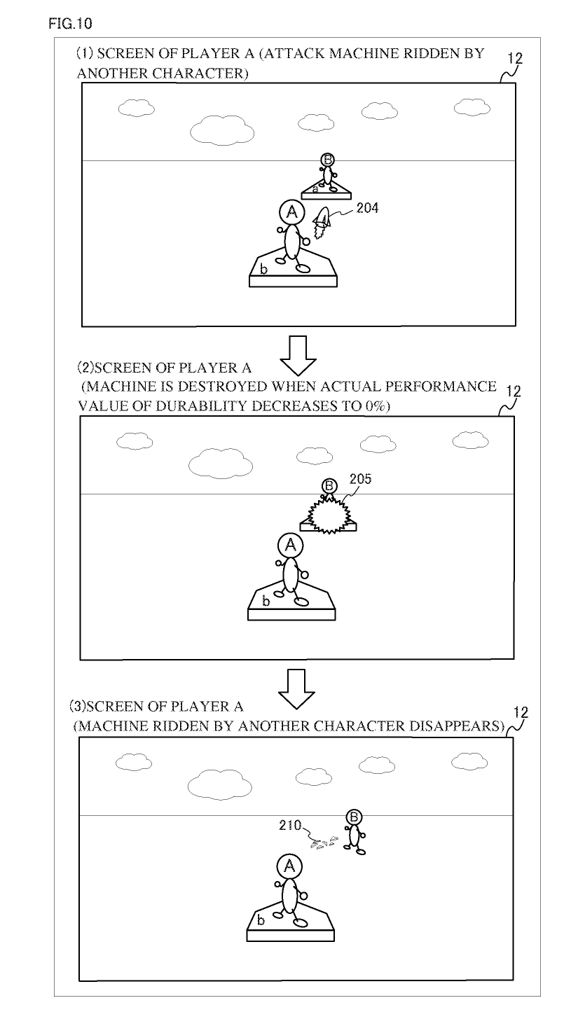

FIG. 10 illustrates a scene in which, in the first game, a character riding a machine attacks another machine being ridden by another character (which can be regarded as the other character itself), reducing the actual performance value of durability (see FIG. 7) of the other machine and ultimately destroying the other machine. If the attack is successful, the actual performance value of durability of the attacked machine is decreased by a percentage (or numerical amount) corresponding to the attack. For example, when the machine c having an actual performance value of durability shown in FIG. 7 is attacked, the actual performance value of durability is decreased from 72 to 36, and, as a result, the current durability ratio is decreased from 50% to 25%. Hereinafter, a case where the character A riding the machine b and operated by the player A attacks the machine a being ridden by the character B operated by the player B, will be specifically described as one example.

In response to a predetermined operation (attack instruction) performed by the player A, a missile 204 is fired from the machine b toward the machine a (see FIG. 10(1)). If the missile 204 hits the machine a, and the attack becomes successful with the display of an effect 205 showing an explosion, the actual performance value of durability of the machine a (see FIG. 7) decreases, and if this actual performance value decreases to 0 (or below 0), the machine a is destroyed (see FIG. 10(2)). Then, the destroyed machine a becomes a wreckage 210, which cannot be boarded by any character, and substantially disappears from the stage of the first game, causing the character B to transition to an on-foot state (see FIG. 10(3)).

There are various types of attacks against machines, and for example, the attack may be a ramming attack in which a machine ridden by a character rams another machine. In the case of a ramming attack, the attacked machine and character may be blown away and moved by a predetermined distance. At that time, the attacked machine may receive damage and the actual performance value of durability thereof may be decreased, or the attacked machine may receive no damage. Further, the wreckage 210 need not be displayed, and the destroyed machine may disappear without leaving any wreckage. The actual performance value of durability is also decreased, for example, when a machine falls off the stage while being ridden by a character, or is attacked by a certain non‑player character (a mob character or the like). In predetermined situations in which damage is received (for example, a machine falls off the stage), the actual performance value of durability may be decreased by a predetermined percentage of the maximum value for the actual performance value of durability (144 in FIG. 7), or may be decreased by a predetermined percentage of the current actual performance value of durability. It is noted that a ramming action that does not inflict damage may be considered not to be an attack.

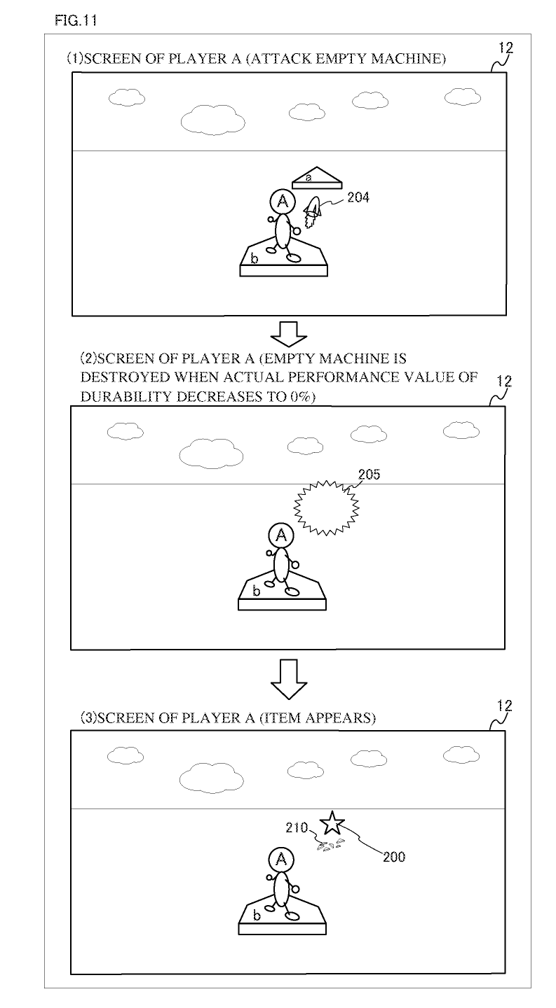

FIG. 11 illustrates a scene in which, in the first game, a character riding a machine attacks an empty machine, reducing the actual performance value of durability (see FIG. 7) of the empty machine and ultimately destroying the empty machine. If the attack is successful, the actual performance value of durability of the attacked empty machine is decreased by a percentage (or numerical amount) corresponding to the attack. For example, a case where the machine c shown in FIG. 7 has transitioned to a state of being an empty machine c is attacked, will be described. In this case, since no riding-character correction and no acquired-item correction are performed, the actual performance value of durability of the empty machine c is 50. Then, when the empty machine c is attacked, the actual performance value of durability is decreased from 50 to 25, and as a result, the current durability ratio is decreased from 50% to 25%. Hereinafter, a case where the character A riding the machine b and operated by the player A attacks an empty machine a, will be specifically described as one example.

In response to a predetermined operation (attack instruction) performed by the player A, a missile 204 is fired from the machine b toward the empty machine a (see FIG. 11(1)). If the missile 204 hits the empty machine a, and the attack becomes successful with the display of an effect 205 showing an explosion, the actual performance value of durability of the empty machine a decreases, and if this actual performance value decreases to 0 (or below 0), the empty machine a is destroyed (see FIG. 11(2)). Then, the destroyed empty machine a becomes a wreckage 210, which cannot be boarded by any character, and substantially disappears from the stage of the first game (see FIG. 11(3)).

There are various types of attacks against empty machines, and for example, the attack may be a ramming attack. In the case of a ramming attack, the attacked empty machine may be blown away and moved by a predetermined distance. At that time, the attacked empty machine may receive damage and the actual performance value of durability thereof may be decreased, or the attacked empty machine may receive no damage. Further, the wreckage 210 may not necessarily be displayed, and the destroyed empty machine may disappear without leaving any wreckage. It is noted that a ramming action that does not inflict damage may be considered not to be an attack.

Further, for example, only in a predetermined case (for example, while a predetermined in‑game event is being executed in the first game), if an empty machine is destroyed, an item appears at a position corresponding to the position at which the empty machine was destroyed. In FIG. 11(3), an item 200 appears at the position at which the empty machine was destroyed.

### Empty machine guard

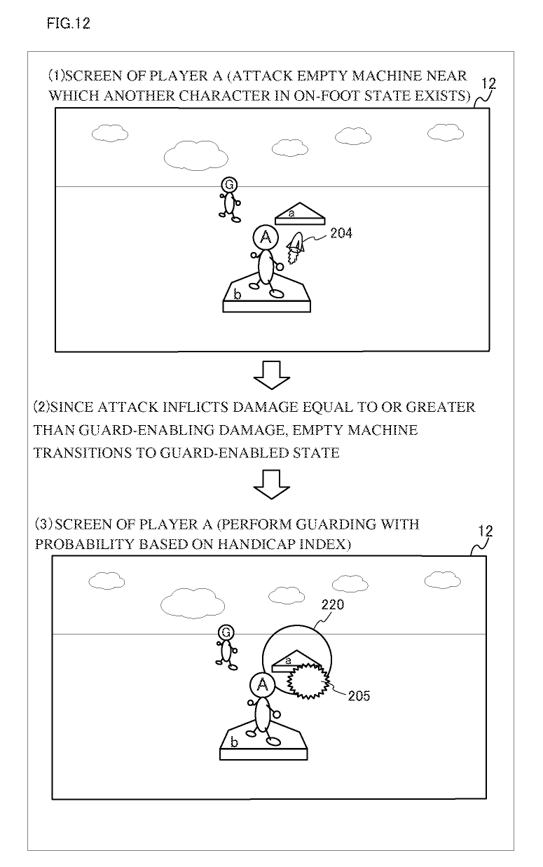

FIG. 12 illustrates a scene in which, in the first game, when an empty machine is attacked by a character riding a machine, the empty machine is guarded (sometimes referred to as “empty machine guard”) and does not receive damage. In the exemplary embodiment, if a predetermined condition (sometimes referred to as “guard occurrence condition”) is satisfied, an empty machine is guarded and does not receive damage. The details will be described below.

In order for the guard occurrence condition to be satisfied, the following listed conditions need to be satisfied.
(1) The current time is within a period from the start of the first game (for example, having an execution time of 5 minutes) until a predetermined time (for example, 2 minutes) has elapsed.
(2) One or more walking characters are located within a predetermined distance (for example, 5 m; for example, a distance at which a walking character can board an empty machine) from an empty machine.
(3) The rank of the number of items acquired by the walking character described above is a rank included in a predetermined lower percentage (for example, the lower 70%).
(4) An attack that inflicts damage equal to or greater than “guard‑enabling damage” described later is performed on the empty machine.
(5) It is determined that the empty machine guard is to be performed with a probability corresponding to the number of items acquired by the walking character described above (which can also be regarded as the rank of the number of acquired items or the like) (when a plurality of walking characters are located within the predetermined distance from the empty machine, the highest probability is used).

In another exemplary embodiment, one or more of the above conditions that cannot necessarily be said to be required may be excluded.

In the above description, the empty machine guard is performed when the guard occurrence condition is satisfied. This content can also be regarded as a content of performing the empty machine guard when a condition for preventing the occurrence of guarding of the empty machine (guard non‑occurrence condition) is not satisfied. That is, satisfaction of the guard occurrence condition can be considered as non‑satisfaction of the guard non‑occurrence condition.

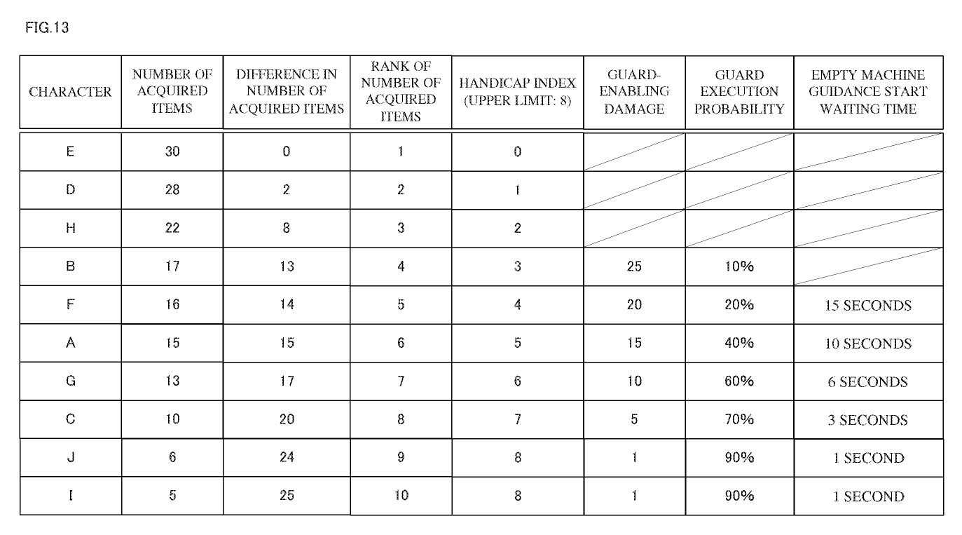

FIG. 13 illustrates values related to the empty machine guard and empty machine guidance described later, based on the number of acquired items. The details will be described below with reference to FIG. 13. FIG. 13 shows a case where characters A to J participate in the first game. “Number of acquired items” indicates the current number of items acquired by each character. In FIG. 13, the character E has the largest number, which is 30, and the character I has the smallest number, which is 5. “Difference in number of acquired items” indicates a difference from the largest number of acquired items. In FIG. 13, the character E has the largest difference, which is 25. “Rank of number of acquired items” indicates a rank obtained by arranging the numbers of acquired items in descending order. In FIG. 13, the character E is ranked first, and the character I is ranked tenth.

“Handicap index” is a parameter for supporting characters having a smaller number of acquired items, and has a value that is larger as the rank of the number of acquired items becomes lower. However, the handicap index has an upper limit (the upper limit is 8 in FIG. 13). In FIG. 13, the handicap index is 0 for the character E, 1 for the character D, 2 for the character H, 3 for the character B, 4 for the character F, 5 for the character A, 6 for the character G, 7 for the character C, and 8 for the characters J and I. The handicap index may not necessarily have an upper limit. Further, when an item that decreases a machine characteristic value is acquired, the number of such items may not necessarily be counted as part of the number of acquired items, or the number of such items may be excluded from the count and further subtracted from the number of acquired items. Further, in addition to the handicap index corresponding to the number of acquired items shown in FIG. 13, or instead of the handicap index, a handicap index that can be freely set by a user before the start of a competitive game or the like may be provided.

“Guard‑enabling damage” is a parameter for setting an empty machine to a “guard‑enabled state” in which guarding of the empty machine is enabled for a predetermined time (for example, 5 seconds), in accordance with damage caused by attacks received by the empty machine within a predetermined time (for example, 10 seconds). The guard‑enabling damage is set for a character whose rank of the number of acquired items is included in a predetermined lower percentage (for example, the lower 70%), and has a value that becomes smaller as the rank of the number of acquired items becomes lower. The guard‑enabling damage has a lower limit (the lower limit is 1 in FIG. 13). The guard‑enabling damage can also be said to have a value that becomes smaller as the handicap index becomes larger. In FIG. 13, the guard‑enabling damage is not set for the characters E, D, and H, and is 25 for the character B, 20 for the character F, 15 for the character A, 10 for the character G, 5 for the character C, and 1 for the characters J and I.

The lower limit of the guard‑enabling damage may be set to 0 (zero). In such a case, when a walking character corresponding to guard‑enabling damage of 0 exists near an empty machine (for example, within 5 m), the empty machine is always brought into a guard‑enabled state. Further, the guard‑enabling damage may be determined according to the machine. For example, the guard‑enabling damage may be determined in accordance with a percentage relative to the machine characteristic value of durability (see FIG. 7) of the empty machine. For example, a value of 8, which is 10% of a machine characteristic value of 80 for the durability of the empty machine, may be set as the guard‑enabling damage.

“Guard execution probability” is a probability that, when an empty machine in a guard‑enabled state is attacked, the empty machine is guarded so as not to receive damage. The guard execution probability has a value that is larger as the rank of the number of acquired items becomes lower. The guard execution probability has an upper limit (the upper limit is 90% in FIG. 13). The guard execution probability can also be said to have a value that is larger as the handicap index becomes larger. In FIG. 13, the guard execution probability is set for the characters E, D, and H, and is 10% for the character B, 20% for the character F, 40% for the character A, 60% for the character G, 70% for the character C, and 90% for the characters J and I.

“Empty machine guidance start waiting time”, which will be described later, is a parameter indicating a waiting time from when a character transitions to an on-foot state until guidance of an empty machine is started, in a case where the empty machine is guided (moved) to a position close to the walking character (for example, a position 3 m from the walking character). The empty machine guidance start waiting time is set for a character to which an empty machine is guided and whose rank of the number of acquired items is included in a predetermined lower percentage (for example, the lower 60%), and has a value that becomes smaller as the rank of the number of acquired items becomes lower. The empty machine guidance start waiting time has a lower limit (the lower limit is 1 second in FIG. 13). The empty machine guidance start waiting time can also be said to have a value that becomes smaller as the handicap index becomes larger. In FIG. 13, the empty machine guidance start waiting time is not set for the characters E, D, H, and B and is 15 seconds for the character F, 10 seconds for the character A, 6 seconds for the character G, 3 seconds for the character C, and 1 second for the characters J and I.

Hereinafter, an example of a scene in which an empty machine is guarded in a situation corresponding to the item acquisition status of each character shown in FIG. 13, will be described with reference to FIG. 12. During a period from the start of the first game until a predetermined time (for example, 2 minutes) has elapsed, a walking character G is located within a predetermined distance (for example, 5 m; a distance at which a walking character can board an empty machine) from an empty machine a. Since the number of items acquired by the walking character G is 13, the rank of the number of items acquired by the walking character G is included in a predetermined lower percentage (the lower 70%) (see FIG. 13). Further, as shown in FIG. 12(1), a missile 204 is fired from the machine b ridden by the character A, toward the empty machine a.

Since the guard‑enabling damage for the walking character G is 10 (see FIG. 13), when damage caused by an attack from the machine b within a predetermined time (for example, 10 seconds) is equal to or greater than 10, the empty machine a transitions to a guard‑enabled state. In FIG. 12(2), since the attack by the machine b is an attack that inflicts damage equal to or greater than the guard‑enabling damage of 10, the empty machine a is in the guard‑enabled state. Accordingly, a lottery is performed to determine whether the empty machine guard is to be performed, with a probability of 60% corresponding to the number of items acquired by the walking character G (which may also be regarded as a probability based on the handicap index) (see FIG. 13). In FIG. 12(3), it is determined that the empty machine guard is to be performed, and the empty machine a does not receive damage, so that the actual performance value of durability (see FIG. 7) is not decreased. Further, in FIG. 12(3), an effect 205 indicating an explosion and a guard image 220 for guarding the empty machine a are displayed. If it is determined that the empty machine guard is not to be performed, the empty machine guard is not performed, and therefore, as usual, the attacked machine receives damage.

### Empty machine guidance

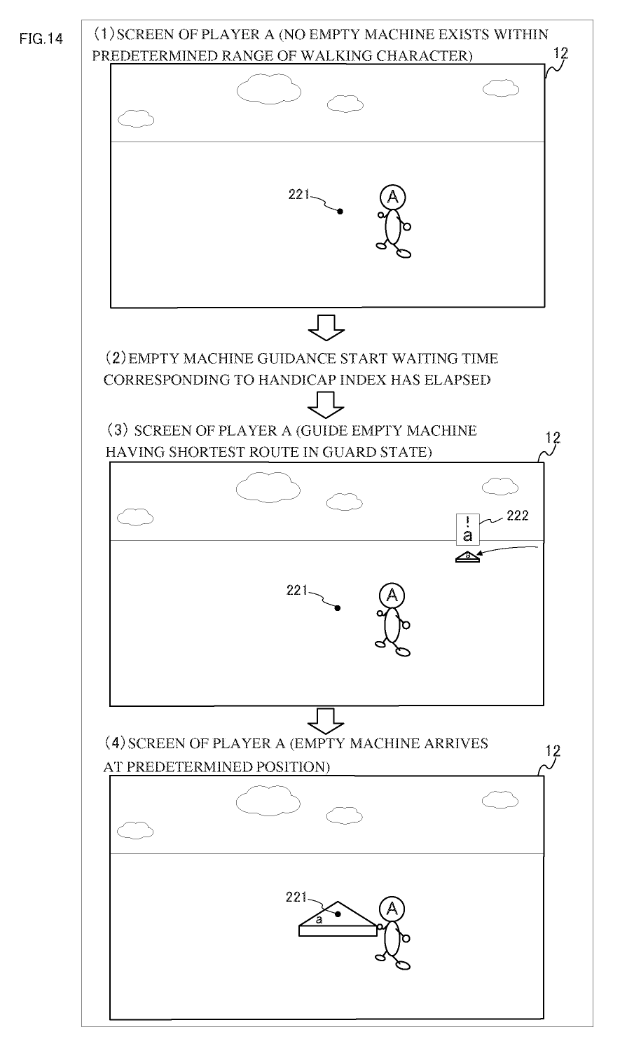

FIG. 14 illustrates a scene in which, in the first game, an empty machine is guided and placed near a walking character (for example, at a position 3 m from the walking character). In the exemplary embodiment, if a predetermined condition (sometimes referred to as “guidance condition”) is satisfied, an empty machine is guided and placed near a walking character. The details will be described below.

In order for the guidance condition to be satisfied, the following conditions (1) and (2) need to be satisfied.
(1) A walking character in an “empty machine guidance waiting state” exists. The empty machine guidance waiting state is a state that is set for a walking character from which no empty machine exists within a predetermined distance (for example, 10 m) and whose rank of the number of acquired items is included in a predetermined lower percentage (for example, the lower 60%). The empty machine guidance waiting state is set when the empty machine guidance start waiting time (see FIG. 13) has elapsed.
(2) An empty machine that satisfies the following conditions (3) to (7) exists.
(3) The empty machine exists within a predetermined range (for example, 100 m) from the walking character in the empty machine guidance waiting state.
(4) The empty machine is not an empty machine for which a predetermined time (for example, 20 seconds) has not elapsed after a character dismounted therefrom and the machine became empty. It is preferable that this predetermined time (for example, 20 seconds) is longer than the empty machine guidance start waiting time. (5) The empty machine is not an empty machine that is scheduled to exit (disappear from) the stage of the first game within a predetermined time (for example, 30 seconds) as a result of not being ridden by any character for a predetermined time (for example, 2 minutes).
(6) The empty machine is not an empty machine whose durability ratio (see FIG. 7) is equal to or less than a predetermined value (for example, 30%).
(7) The empty machine is not an empty machine that is currently being guided.
   If the guidance conditions (1) and (2) are satisfied, among the empty machines that satisfy the conditions (3) to (7), the empty machine having the shortest route to the walking character in the empty machine guidance waiting state is selected as a guidance target.
   In another exemplary embodiment, one or more of the above conditions that cannot necessarily be said to be required may be excluded.

Hereinafter, an example of a scene in which an empty machine is guided and placed near a walking character in a situation corresponding to the item acquisition status of each character shown in FIG. 13, will be described with reference to FIG. 14. In the first game, a walking character A from which no empty machine exists within a predetermined distance (for example, 10 m) exists (see FIG. 14(1)). The walking character A is a character whose rank of the number of acquired items is included in the lower 60% (see FIG. 13; fifth place or lower).

Then, when an empty machine guidance start waiting time of 10 seconds for the walking character A elapses (see FIG. 13 and FIG. 14(2)), an empty machine that satisfies the above guidance condition is guided toward a predetermined position close to the walking character A (see FIG. 14(3)). This predetermined position is the position of a gaze point 221 of a virtual camera that takes an image of the walking character A, and is within a predetermined range (for example, within 3 m) from the walking character A. The predetermined position may be a position within a predetermined range (for example, within 1 m) from the gaze point 221 and within a predetermined range (for example, within 3 m) from the walking character A. When no empty machine that satisfies the above guidance condition exists, no empty machine is guided.

In FIG. 14(3), an empty machine a is guided toward the gaze point 221. In addition, a display 222 including an indication “a” by which the type of the empty machine a can be visually recognized and an indication “!” indicating that the empty machine is being guided is added to the empty machine a. Further, an empty machine being guided is brought into a guard state in which the empty machine does not receive damage even if attacked.

The empty machine a is guided to and arrives at the position of the gaze point 221 (see FIG. 14(4)). As a result, the walking character A can promptly board the empty machine a.

In the above description, when no empty machine that is to be guided exists within 10 m from the walking character A, an empty machine is guided and caused to arrive at a position within 3 m from the walking character A. Here, a case where control is performed such that an empty machine is guided and caused to arrive at a position 9 m from the walking character A, is considered. In this case, after an empty machine a arrives at a position 9 m from the walking character A, if the walking character A moves by 1 m or more and becomes separated from the empty machine a by 10 m or more, the empty machine a is guided again, which may cause the player to feel annoyed. Therefore, in the exemplary embodiment, as described above, the two distances (10 m and 3 m) are set to values that are separated from each other by a certain margin.

### Second game

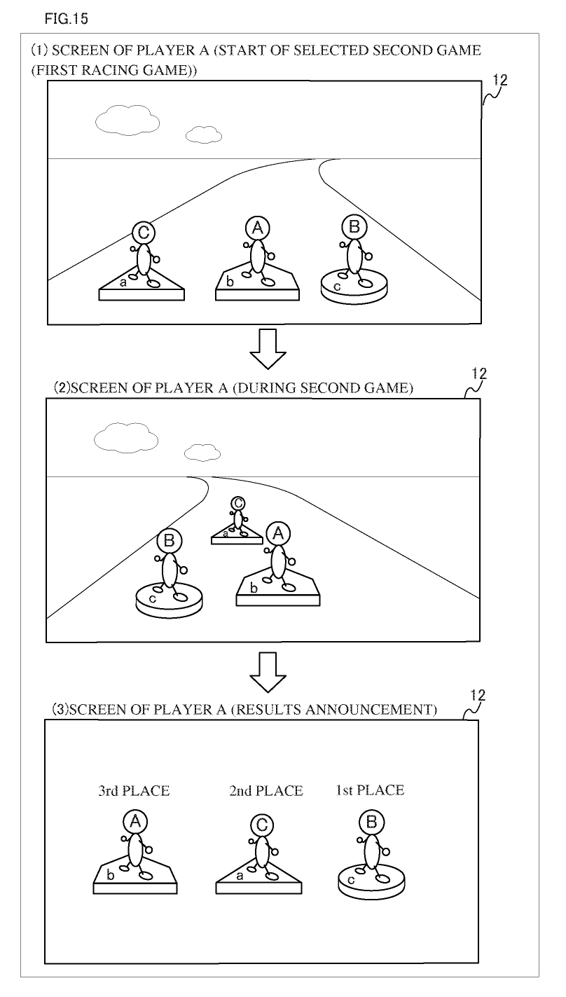

FIG. 15 illustrates the second game which is performed after the first game ends. In FIG. 15, the first race game (one of four types of second games), in which characters can hardly attack each other and which has many straight sections, is shown as an example. As previously described, after the first game ends, each player selects which second game to participate in. The second game is started with each character riding the machine that had been ridden by the character at the end of the first game, and in the second game, each character retains the items that change the actual performance values of the machine and that have been acquired in the first game. That is, the actual performance values at the end of the first game (see FIG. 7) are carried over at the start of the second game. Items other than those that change the actual performance values (for example, missile 240) may not necessarily be carried over to a third game. The actual performance value of durability (see FIG. 7) may be returned to its maximum value (or by a predetermined percentage thereof) at the start of the second game. A character that had been in an on-foot state at the end of the first game boards a specific machine (for example, a machine whose machine characteristic values are generally lower than those of other machines) and participates in the second game. This specific machine may be a machine a or may be any other type of machine. Alternatively, a character that had been in an on-foot state at the end of the first game may participate in the second game in an on-foot state.

When the first race game is started, the characters operated by the players participating in the first race game are placed at the starting position. In FIG. 15(1), the character C riding the machine a, the character A riding the machine b, and the character B riding the machine c are placed at the starting position.

Thereafter, when the race is started, each character riding the machine moves in response to an operation performed by each player, and the race progresses (see FIG. 15(2)). When the race ends, the result of the first race game, which constitutes the result of this competitive game, is displayed (see FIG. 15(3)).

### Details of information processing in exemplary embodiment

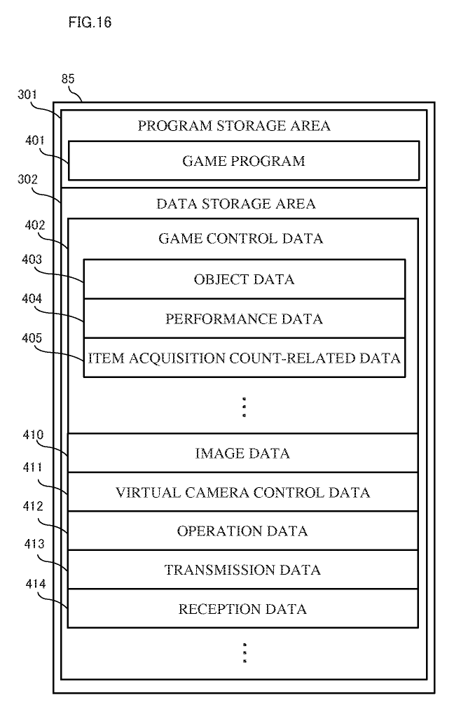

Next, the details of information processing in the exemplary embodiment will be described in detail with reference to FIG. 16 to FIG. 26.

### Data to be used

Various data to be used in this game processing will be described. FIG. 16 shows an example of data stored in the DRAM 85 of the game system 1. As shown in FIG. 16, at least a program storage area 301 and a data storage area 302 are provided in the DRAM 85. In the program storage area 301, a game program 401 is stored. In the data storage area 302, game control data 402, image data 410, virtual camera control data 411, operation data 412, transmission data 413, reception data 414, etc., are stored. The game control data 402 includes object data 403, performance data 404, and item acquisition count‑related data 405.

The game program 401 is a game program for performing the game processing.

The object data 403 is data of objects to be placed in the virtual space, and is data of objects such as a player character, machines, items, terrains, blocks, rocks, stones, trees, and buildings. In addition, the object data 403 includes data of coordinates (positions), orientations, postures, states, etc., of objects.

The performance data 404 is data regarding the contents described with reference to FIG. 7. For example, the performance data 404 includes data indicating the machine characteristic values of each machine, data indicating the values having undergone the riding-character correction for each player character, data indicating the values having undergone the acquired-item correction for each item, data indicating the current durability ratio of the machine, data indicating the actual performance values in a state where the player character is riding a machine, etc.

The item acquisition count‑related data 405 is data regarding the contents described with reference to FIG. 13, and includes data of the number of acquired items, a difference in number of acquired items, the rank of the number of acquired items, a handicap index, guard‑enabling damage, a guard execution probability, and an empty machine guidance start waiting time.

The image data 410 is image data of backgrounds, virtual effects, etc.

The virtual camera control data 411 is data for controlling the movement of the virtual camera placed in the virtual space. Specifically, the virtual camera control data 411 is data for designating the position, the orientation, the angle of view, the imaging direction, the gaze point, etc., of the virtual camera.

The operation data 412 is data indicating the contents of operations performed on the left controller 3 and the right controller 4. The contents of the operation data are updated at predetermined cycles on the basis of signals from the left controller 3 and the right controller 4.

The transmission data 413 is data to be transmitted to another game system 1, and includes at least information for identifying a transmission source and the contents of the operation data 412. The transmission data 413 includes data (data indicating the coordinates (position), the posture, the state, etc.) regarding the own player character, to be transmitted to other game systems 1 of multiplayer opponents (or to a server), etc.

The received data 414 is transmission data received from other game systems 1 and stored so as to be able to be identified for each of the other game systems 1 (i.e., for each transmission source). The received data 414 includes data (data indicating the coordinates (positions), the postures, the states, etc.) regarding other player characters, etc., received from the other game systems 1 of the multiplayer opponents (or from the server).

In addition, various data to be used in the game processing are stored as necessary in the DRAM 85.

### Details of game processing

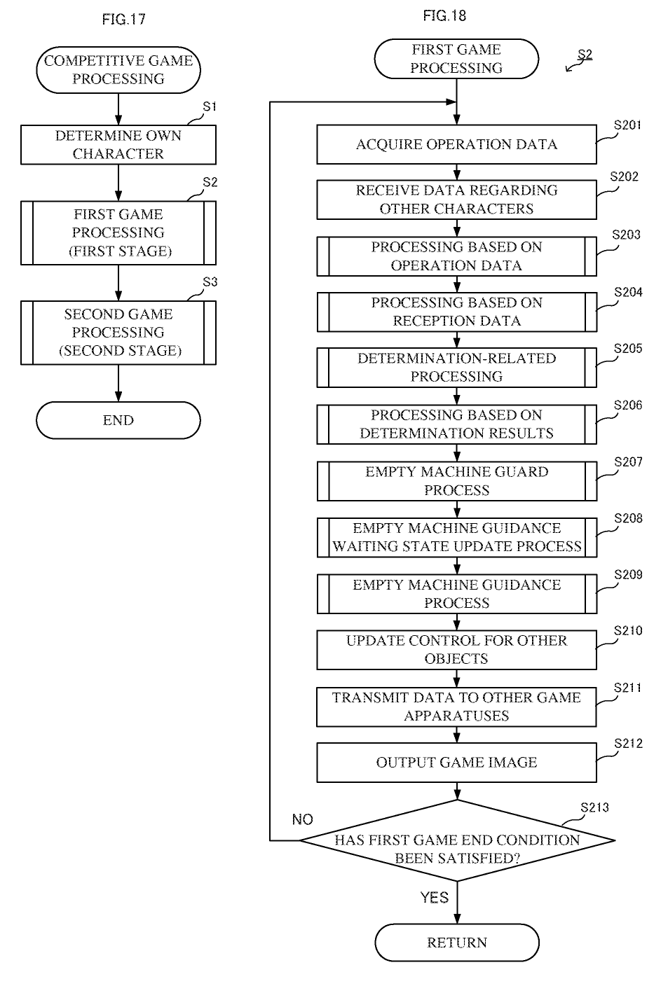

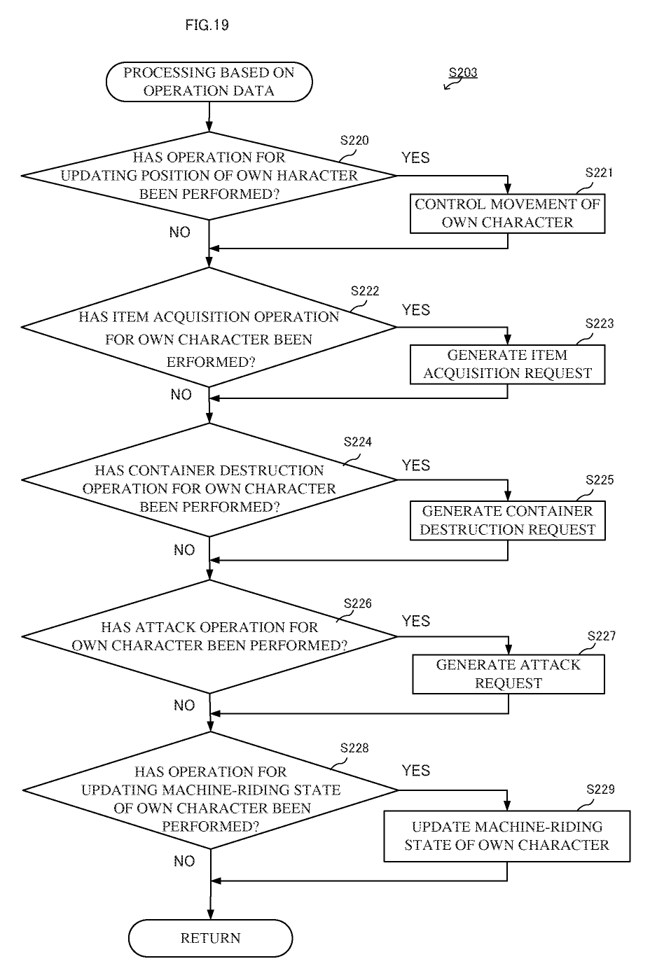

Next, the details of the game processing according to the exemplary embodiment will be described with reference to flowcharts. FIGS. 17 to 26 are each an example of a flowchart showing the details of the game processing according to the exemplary embodiment. In the following description, processing characteristic to the exemplary embodiment will be described, and the description for other processing such as rendering processing is omitted. In addition, first game processing and second game processing in FIGS. 18 to 26 are performed at predetermined intervals (for example, at frame intervals in processing executed every 1/60 second).

When the game processing is started and the competitive game is started, competitive game processing in FIG. 17 is started.

In step S1 in FIG. 17, the processor 81 determines the own character selected by the player, based on the operation data 412. The processor 81 acquires information such as the characters selected by the other players from the other game apparatuses of the multiplayer opponents, based on the reception data 414. Then, the processing proceeds to step S2. In the exemplary embodiment, as one example, it is assumed that multiple game apparatuses with which a multiplayer game is played communicate with each other, generate substantially the same virtual space in synchronization, and progress the multiplayer game.

FIGS. 18 to 25 are each an example of a flowchart of the first game processing in step S. The first game processing is processing for executing the first game described with reference to FIGS. 4 to 14.

In step S201 in FIG. 18, the processor 81 acquires the operation data 412. Then, the processing proceeds to step S202.

In step S202, the processor 81 acquires data regarding the other characters of the multiplayer opponents, based on the reception data 414. The data is, for example, data indicating the current positions (coordinates, etc.), the machine-riding states, etc., of the other characters. Then, the processing proceeds to step S203.

In step S203, the processor 81 performs processing based on the operation data 412. FIG. 19 is an example of a flowchart of the processing in step S203 based on the operation data.

In step S220 in FIG. 19, the processor 81 determines whether or not an operation for updating the position of the own character has been performed. If the determination result in step S220 is YES, the processing proceeds to step S221, and if the determination result in step S220 is NO, the processing proceeds to step S222.

In step S221, the processor 81 controls the movement of the own character. For example, the processor 81 performs control to move the own character in an on-foot state or in a machine-riding state (see FIG. 5(1) and FIG. 8(1)). Then, the processing proceeds to step S222.

In step S222, the processor 81 determines whether or not an item acquisition operation for the own character has been performed. For example, the processor 81 determines whether or not the own character riding a machine has entered a predetermined range of an item by moving or the like (see FIG. 5). If the determination result in step S222 is YES, the processing proceeds to step S223, and if the determination result in step S222 is NO, the processing proceeds to step S224.

In step S223, the processor 81 generates an item acquisition request. Then, the processing proceeds to step S224.

In step S224, the processor 81 determines whether or not a container destruction operation for the own character has been performed. If the determination result in step S224 is YES, the processing proceeds to step S225, and if the determination result in step S224 is NO, the processing proceeds to step S226.

In step S225, the processor 81 generates a container destruction request. Then, the processing proceeds to step S226.

In step S226, the processor 81 determines whether or not an attack operation for the own character has been performed. For example, the processor 81 determines whether or not an attack operation (including a ramming operation) against a machine being ridden by another character or an attack operation (including a ramming operation) against an empty machine has been performed (see FIGS. 10 and 11). If the determination result in step S226 is YES, the processing proceeds to step S227, and if the determination result in step S226 is NO, the processing proceeds to step S228.

In step S227, the processor 81 generates an attack request. Then, the processing proceeds to step S228.

In step S228, the processor 81 determines whether or not an operation for updating the machine‑riding state of the own character has been performed. For example, the processor 81 determines whether or not an operation for causing the own character in an on-foot state to board an empty machine, an operation for causing the own character riding a machine to dismount from the machine and transition to an on-foot state, an operation for causing the own character riding a machine to directly switch to another empty machine, or the like has been performed (see FIGS. 8 and 9). If the determination result in step S228 is YES, the processing proceeds to step S229, and if the determination result in step S228 is NO, the processing proceeds to step S204 in FIG. 18.

In step S229, the processor 81 updates the machine‑riding state of the own character in accordance with the operation determined in step S228 (see FIGS. 8 and 9). Then, the processing proceeds to step S204 in FIG. 18.

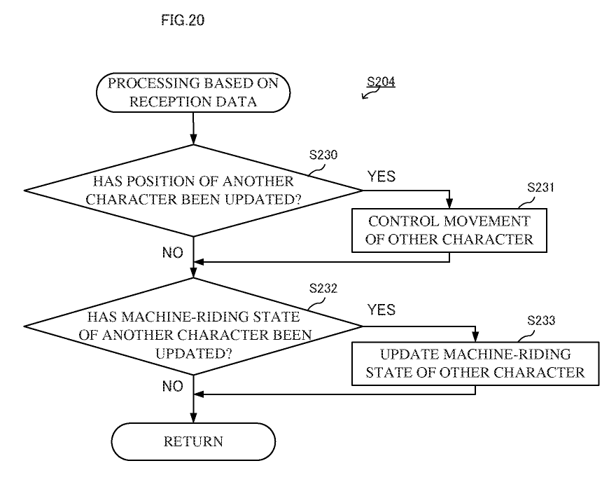

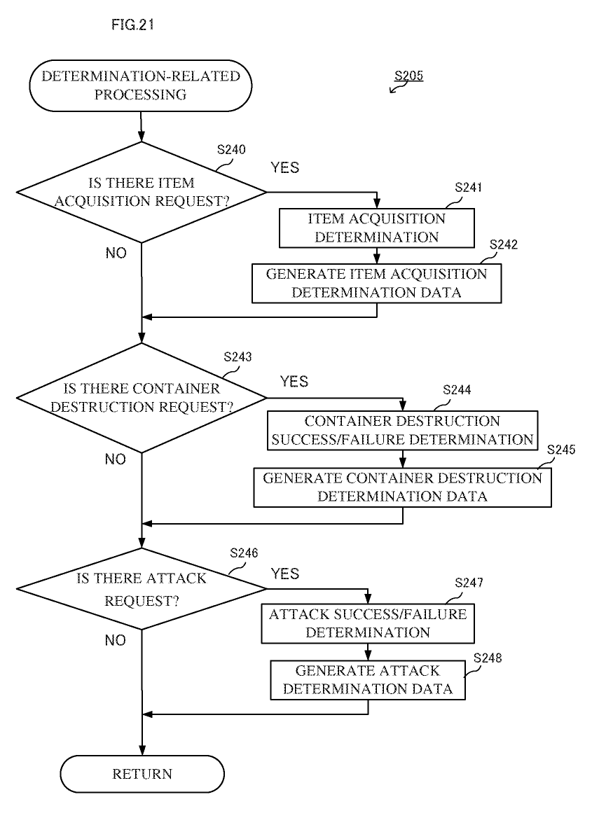

In step S204 in FIG. 18, the processor 81 performs processing based on the reception data 414. FIG. 20 is an example of a flowchart of the processing in step S204 based on the reception data.

In step S230 in FIG. 20, the processor 81 determines whether or not the position of another character has been updated in the game apparatus of a multiplayer opponent. If the determination result in step S230 is YES, the processing proceeds to step S231, and if the determination result in step S230 is NO, the processing proceeds to step S232.

In step S231, the processor 81 controls the movement of the other character. For example, the processor 81 performs control to move the other character in an on-foot state or in a state of riding a machine. Then, the processing proceeds to step S232.

In step S232, the processor 81 determines whether or not the machine‑riding state of another character has been updated in the game apparatus of a multiplayer opponent. For example, the processor 81 determines whether or not update in which the other character in an on-foot state is caused to board an empty machine, update in which the other character riding a machine is caused to dismount from the machine, update in which the other character riding a machine is caused to directly switch to another empty machine, or the like has been performed. If the determination result in step S232 is YES, the processing proceeds to step S233, and if the determination result in step S232 is NO, the processing proceeds to step S205 in FIG. 18.

In step S233, the processor 81 updates the machine‑riding state of the other character in accordance with the determination in step S232. Then, the processing proceeds to step S205 in FIG. 18.

In step S205 in FIG. 18, the processor 81 performs determination-related processing. FIG. 21 is an example of a flowchart of the determination-related processing in step S205.

In step S240 in FIG. 21, the processor 81 determines whether or not an item acquisition request has been generated in step S223, that is, determines whether or not there is an item acquisition request. If the determination result in step S240 is YES, the processing proceeds to step S241, and if the determination result in step S240 is NO, the processing proceeds to step S243.

In step S241, the processor 81 performs an item acquisition determination based on a predetermined condition. For example, as described with reference to FIG. 5, the processor 81 performs the item acquisition determination based on a predetermined condition that, if the own character is in a state of riding a machine, it is determined that the item acquisition is successful, and if the own character is in an on-foot state, it is determined that the item acquisition fails. The determination condition for the item acquisition determination may be another condition. Then, the processing proceeds to step S242.

In step S242, the processor 81 generates item acquisition determination data indicating the determination result in step S241. Then, the processing proceeds to step S243.

In step S243, the processor 81 determines whether or not a container destruction request has been generated in step S225, that is, determines whether or not there is a container destruction request. If the determination result in step S243 is YES, the processing proceeds to step S244, and if the determination result in step S243 is NO, the processing proceeds to step S246.

In step S244, the processor 81 performs a container destruction success/failure determination based on a predetermined condition. For example, if a missile fired from the machine being ridden by the own character hits a container, the processor 81 determines that the destruction is successful (see FIG. 6). Then, the processing proceeds to step S245.

In step S245, the processor 81 generates container destruction determination data indicating the determination result in step S244. Then, the processing proceeds to step S246.

In step S246, the processor 81 determines whether or not an attack request has been generated in step S227, that is, determines whether or not there is an attack request. If the determination result in step S246 is YES, the processing proceeds to step S247, and if the determination result in step S246 is NO, the processing proceeds to step S206 in FIG. 18.

In step S247, the processor 81 performs an attack success/failure determination based on a predetermined condition. For example, if a missile fired from the machine being ridden by the own character hits a machine being ridden by another character (which can be regarded as the other character itself), the processor 81 determines that the attack is successful (see FIG. 10). Further, for example, if a missile fired from the machine being ridden by the own character hits an empty machine, the processor 81 determines that the attack is successful (see FIG. 11). Further, for example, if the machine being ridden by the own character performs a ramming attack against a machine being ridden by another character or an empty machine, the processor 81 determines that the attack is successful. Then, the processing proceeds to step S248.

In step S248, the processor 81 generates attack determination data indicating the determination result in step S247. Then, the processing proceeds to step S206 in FIG. 18.

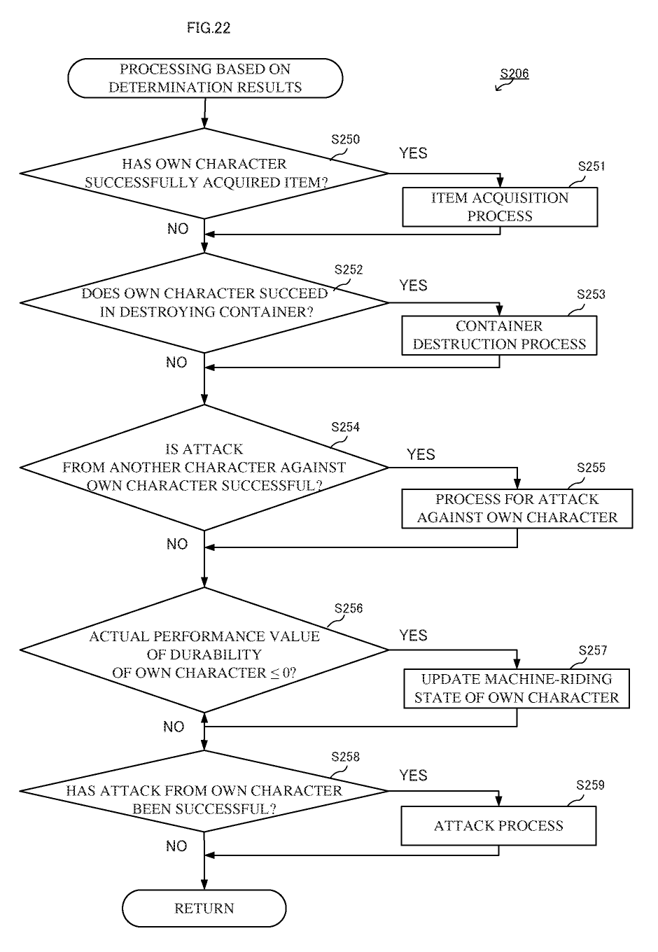

In step S206 in FIG. 18, the processor 81 performs processing based on the determination results. FIG. 22 is an example of a flowchart of the processing in step S206 based on the determination results.

In step S250 in FIG. 22, the processor 81 determines whether or not the own character has successfully acquired an item, based on the item acquisition determination data generated in step S242. If the determination result in step S250 is YES, the processing proceeds to step S251, and if the determination result in step S250 is NO, the processing proceeds to step S252.

In step S251, the processor 81 performs an item acquisition process of causing the own character to acquire the item (see FIG. 5). Then, the processing proceeds to step S252.

In step S252, the processor 81 determines whether or not the own character succeeds in destroying a container, based on the container destruction determination data generated in step S245. If the determination result in step S252 is YES, the processing proceeds to step S253, and if the determination result in step S252 is NO, the processing proceeds to step S254.

In step S253, the processor 81 performs a container destruction process of causing the own character to destroy the container (see FIG. 6). Then, the processing proceeds to step S254.

In step S254, the processor 81 determines whether or not an attack from another character against the own character is successful, based on the reception data 414. This determination is performed based on attack determination data generated in step S248 in another game apparatus of a multiplayer opponent and received from the other game apparatus. If the determination result in step S254 is YES, the processing proceeds to step S255, and if the determination result in step S254 is NO, the processing proceeds to step S256.

In step S255, the processor 81 performs a process for the attack from the other character against the own character (see FIG. 10). Then, the processing proceeds to step S256.

In step S256, the processor 81 determines whether the actual performance value of durability (see FIG. 7) of the own character in a state of riding a machine is 0 (zero) or less, based on the performance data 404. If the determination result in step S256 is YES, the processing proceeds to step S257, and if the determination result in step S256 is NO, the processing proceeds to step S258.

In step S257, the processor 81 updates the machine‑riding state of the own character. For example, the processor 81 destroys the machine being ridden and causes the own character to transition to a state of not riding a machine (on-foot state) (see FIG. 10(2)). Then, the processing proceeds to step S258.

In step S258, the processor 81 determines whether or not an attack from the own character is successful. This determination is performed based on the attack determination data generated in step S248. If the determination result in in step S258 is YES, the processing proceeds to step S259, and if the determination result in in step S258 is NO, the processing proceeds to step S207 in FIG. 18.

In step S259, the processor 81 performs an attack process (see FIGS. 10 and 11). Then, the processing proceeds to step S207 in FIG. 18.

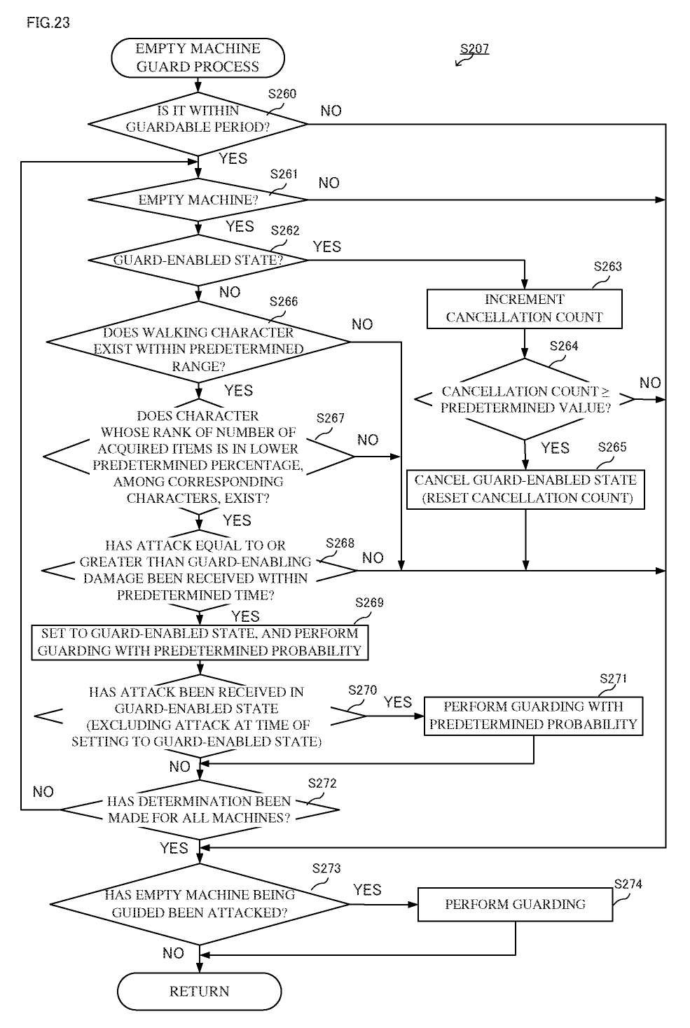

In step S207 in FIG. 18, the processor 81 performs an empty machine guard process. FIG. 23 is an example of a flowchart of the empty machine guard process in step S207. For example, the empty machine guard process may be performed on a server communicably connected to the main body apparatus 2.

In step S260 in FIG. 23, the processor 81 determines whether or not the current time is within a guardable period. For example, the processor 81 determines whether or not the current time is within a period from the start of the first game (for example, having an execution time of 5 minutes) until a predetermined time (for example, 2 minutes) has elapsed, as described with reference to FIG. 12. If the determination result in step S260 is YES, the processing proceeds to step S261, and if the determination result in step S260 is NO, the processing proceeds to step S273.

In step S261, the processor 81 determines whether or not the machine for which determination is to be performed is an empty machine. If the determination result in step S261 is YES, the processing proceeds to step S262, and if the determination result in step S261 is NO, the processing proceeds to step S273.

In step S262, the processor 81 determines whether or not the empty machine for which determination is to be performed is in a guard‑enabled state. If the determination result in step S262 is YES, the processing proceeds to step S263, and if the determination result in step S262 is NO, the processing proceeds to step S266.

In step S263, the processor 81 increments a cancellation count for canceling the guard‑enabled state of the empty machine for which determination is to be performed (for example, 5 seconds). Then, the processing proceeds to step S264.

In step S264, the processor 81 determines whether or not the cancellation count has become equal to or greater than a predetermined value (for example, 5 seconds). If the determination result in step S264 is YES, the processing proceeds to step S265, and if the determination result in step S264 is NO, the processing proceeds to step S273.

In step S265, the processor 81 cancels the guard‑enabled state of the empty machine for which determination is to be performed and resets the value of the cancellation count. Then, the processing proceeds to step S273.

In step S266, the processor 81 determines whether or not a walking character exists within a predetermined range (for example, 5 m) of the empty machine for which determination is to be performed. If the determination result in step S266 is YES, the processing proceeds to step S267, and if the determination result in step S266 is NO, the processing proceeds to step S273.

In step S267, the processor 81 determines whether or not, among the walking characters determined as YES in step S266, a walking character whose rank of the number of acquired items is included in a lower predetermined percentage (for example, 70%; see FIG. 13) exists. If the determination result in step S267 is YES, the processing proceeds to step S268, and if the determination result in step S267 is NO, the processing proceeds to step S273.

In step S268, the processor 81 determines whether or not the empty machine for which determination is to be performed has received an attack equal to or greater than guard‑enabling damage, within a predetermined time (for example, 10 seconds) (see FIG. 13). As the above guard‑enabling damage, for example, the guard‑enabling damage for the walking character having the highest handicap index among the walking characters determined as YES in step S267 is used, but the above guard‑enabling damage is not limited thereto. If the determination result in step S268 is YES, the processing proceeds to step S269, and if the determination result in step S268 is NO, the processing proceeds to step S273.

In step S269, the processor 81 sets the empty machine for which determination is to be performed, to a guard‑enabled state, and performs guarding with a predetermined probability (guard execution probability; see FIG. 13) such that this empty machine receives no damage. As the above predetermined probability (guard execution probability), for example, the guard execution probability for the walking character having the highest handicap index among the walking characters determined as YES in step S267 is used, but the above predetermined probability is not limited thereto. Then, the processing proceeds to step S270.

In step S270, the processor 81 determines whether or not the empty machine for which determination is to be performed has been attacked while in the guard‑enabled state. This attack is an attack other than the attack determined as YES in step S268 (the attack at the time when the guard‑enabled state was set). If the determination result in step S270 is YES, the processing proceeds to step S271, and if the determination result in step S270 is NO, the processing proceeds to step S272.

In step S271, the processor 81 performs guarding for the empty machine for which determination is to be performed, with a predetermined probability (guard execution probability; see FIG. 13) such that this empty machine receives no damage. As the above predetermined probability (guard execution probability), for example, the guard execution probability for the walking character having the highest handicap index among the walking characters determined as YES in step S267 is used, but the above predetermined probability is not limited thereto. Then the processing proceeds to step S272.

In step S272, the processor 81 determines whether or not determination has been made for all machines existing in the field of the first game. If the determination result in step S272 is YES, the processing proceeds to step S273, and if the determination result in step S272 is NO, the processing returns to step S261.

In step S273, the processor 81 determines whether or not an empty machine being guided to a walking character (see FIG. 14) has been attacked. If the determination result in step S273 is YES, the processing proceeds to step S274, and if the determination result in step S273 is NO, the processing proceeds to step S208 in FIG. 18.

In step S274, the processor 81 always performs guarding for the empty machine being guided to the walking character such that this empty machine receives no damage. Then, the processing proceeds to step S208 in FIG. 18.

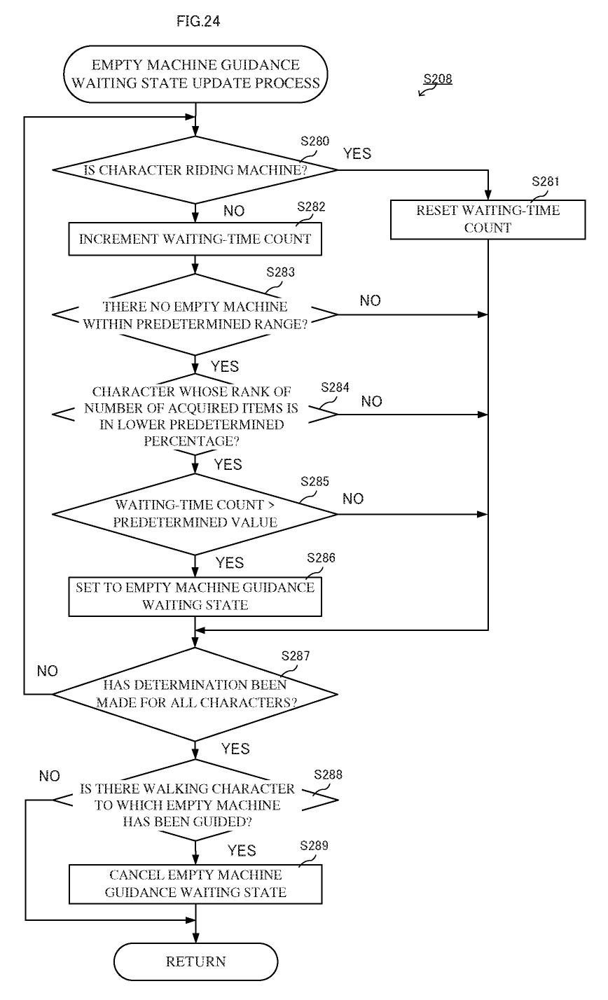

In step S208 in FIG. 18, the processor 81 performs an empty machine guidance waiting state update process. FIG. 24 is an example of a flowchart of the empty machine guidance waiting state update process in step S208.

In step S280 in FIG. 24, the processor 81 determines whether or not the character for which determination is to be performed is currently riding a machine. If the determination result in step S280 is YES, the processing proceeds to step S281, and if the determination result in step S280 is NO, the processing proceeds to step S282.

In step S282, the processor 81 increments a waiting-time count for the walking character for which determination is to be performed. Specifically, the processor 81 increments a count for measuring the empty machine guidance start waiting time described with reference to FIG. 13. Then, the processing proceeds to step S283. The process in step S282 may also be performed if it is determined as YES in step S284.

In step S283, the processor 81 determines whether or not an empty machine exists within a predetermined range (for example, 10 m) of the walking character for which determination is to be performed. If the determination result in step S283 is YES, the processing proceeds to step S284, and if the determination result in step S283 is NO, the processing proceeds to step S287.

In step S284, the processor 81 determines whether or not the walking character for which determination is to be performed is a character whose rank of the number of acquired items is equal to or less than a lower predetermined percentage (for example, equal to or less than 60%; see FIG. 13). If the determination result in step S284 is YES, the processing proceeds to step S285, and if the determination result in step S284 is NO, the processing proceeds to step S287.

In step S285, the processor 81 determines whether or not the waiting-time count for the walking character for which determination is to be performed has exceeded a predetermined value (empty machine guidance start waiting time). If the determination result in step S285 is YES, the processing proceeds to step S286, and if the determination result in step S285 is NO, the processing proceeds to step S287.

In step S286, the processor 81 sets the walking character for which determination is to be performed, to an empty machine guidance waiting state. Then, the processing proceeds to step S287.

Meanwhile, in step S281, the processor 81 resets the value of the waiting-time count. Then, the processing proceeds to step S287.

In step S287, the processor 81 determines whether or not determinations have been made for all characters existing in the field of the first game. If the determination result in step S287 is YES, the processing proceeds to step S288, and if the determination result in step S287 is NO, the processing returns to step S280.

In step S288, the processor 81 determines whether or not there is a walking character to which an empty machine has been guided. If the determination result in step S288 is YES, the processing proceeds to step S289, and if the determination result in step S288 is NO, the processing proceeds to step S209 in FIG. 18.

In step S289, the processor 81 cancels the empty machine guidance waiting state for the walking character determined in step S288. Then, the processing proceeds to step S209 in FIG. 18.

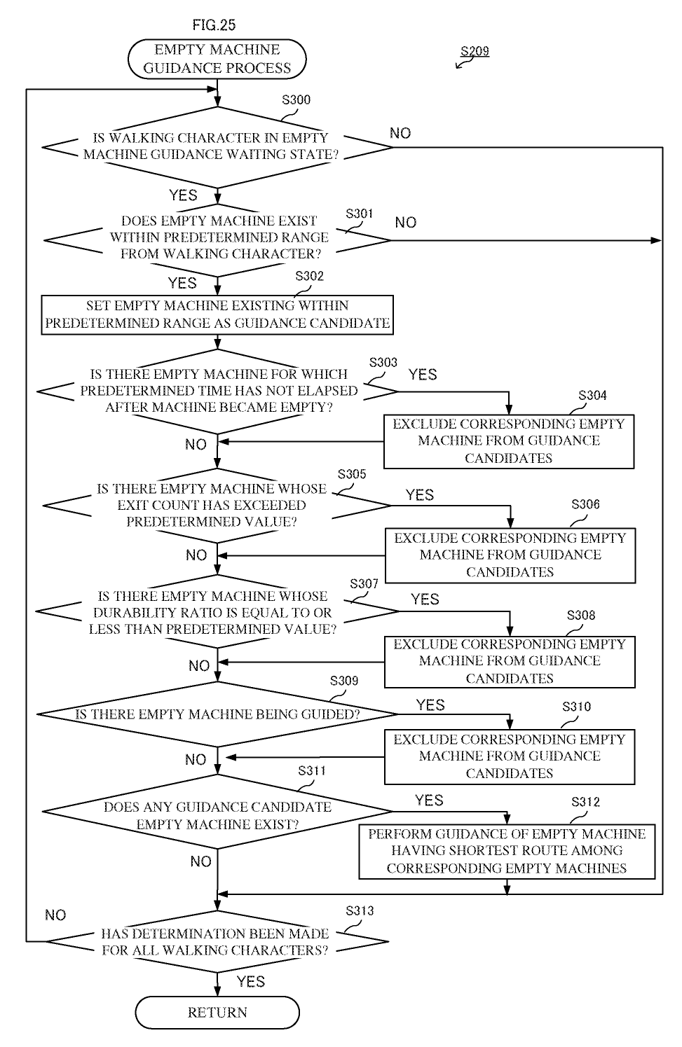

In step S209 in FIG. 18, the processor 81 performs an empty machine guidance process. FIG. 25 is an example of a flowchart of the empty machine guidance process in step S209. For example, the empty machine guidance process may be performed on a server communicably connected to the main body apparatus 2.

In step S300 in FIG. 25, the processor 81 determines whether or not the walking character for which determination is to be performed is in an empty machine guidance waiting state. If the determination result in step S300 is YES, the processing proceeds to step S301, and if the determination result in step S300 is NO, the processing proceeds to step S313.

In step S301, the processor 81 determines whether or not an empty machine exists within a predetermined range (for example, 100 m; sometimes referred to as “empty machine search range”) from the walking character for which determination is to be performed. If the determination result in step S301 is YES, the processing proceeds to step S302, and if the determination result in step S301 is NO, the processing proceeds to step S313.

In step S302, the processor 81 sets, as a “guidance candidate”, any empty machine determined in step S301 to exist within the predetermined range. Then, the processing proceeds to step S303.

In step S303, the processor 81 determines whether or not, among the guidance candidate empty machines, there is an empty machine for which a predetermined time (for example, 20 seconds) has not elapsed after the machine became empty. If the determination result in step S303 is YES, the processing proceeds to step S304, and if the determination result in step S303 is NO, the processing proceeds to step S305.

In step S304, the processor 81 excludes the empty machine determined as YES in step S303 from the guidance candidates. Then, the processing proceeds to step S305.

In step S305, the processor 81 determines whether or not, among the guidance candidate empty machines, there is an empty machine whose exit count for measuring a time during which the machine has not been ridden by any character (for example, 2 minutes) has exceeded a predetermined value (for example, 1 minute and 30 seconds). As already described, an empty machine for which a time during which the machine has not been ridden by any character reaches a predetermined time (for example, 2 minutes) exits the stage of the first game. If the determination result in step S305 is YES, the processing proceeds to step S306, and if the determination result in step S305 is NO, the processing proceeds to step S307.

In step S306, the processor 81 excludes the empty machine determined as YES in step S305 from the guidance candidates. Then, the processing proceeds to step S307.

In step S307, the processor 81 determines whether or not, among the guidance candidate empty machines, there is an empty machine whose durability ratio (see FIG. 7) is equal to or less than a predetermined value (for example, 30%). If the determination result in step S307 is YES, the processing proceeds to step S308, and if the determination result in step S307 is NO, the processing proceeds to step S309.

In step S308, the processor 81 excludes the empty machine determined as YES in step S307 from the guidance candidates. Then, the processing proceeds to step S309.

In step S309, the processor 81 determines whether or not, among the guidance candidate empty machines, there is an empty machine being guided. If the determination result in step S309 is YES, the processing proceeds to step S310, and if the determination result in step S309 is NO, the processing proceeds to step S311.

In step S310, the processor 81 excludes the empty machine determined as YES in step S309 from the guidance candidates. Then, the processing proceeds to step S311.

In step S311, the processor 81 determines whether or not any guidance candidate empty machine exists (that is, remains). If the determination result in step S311 is YES, the processing proceeds to step S312, and if the determination result in step S311 is NO, the processing proceeds to step S313.

In step S312, the processor 81 performs guidance of, among the empty machines determined as YES in step S311, the empty machine having the shortest route from the walking character to which the guidance is performed. Then, the processing proceeds to step S313.

In step S313, the processor 81 determines whether or not determination has been made for all walking characters existing in the field of the first game. If the determination result in step S313 is YES, the processing proceeds to step S210 in FIG. 18, and if the determination result in step S313 is NO, the processing returns to step S300.

In step S210 in FIG. 18, the processor 81 performs update control for objects other than the own character and the other character. For example, the processor 81 performs a process of deleting the items that have been acquired by the characters from the stage. Also, for example, the processor 81 performs a process of destroying a container in accordance with an attack by another character, causing an item to appear from the destroyed container, and destroying an empty machine in accordance with an attack by another character. Then, the processing proceeds to step S211.

In step S211, the processor 81 transmits data for executing multiplayer gameplay, etc., to the other game apparatuses of the other multiplayer opponents. This data may be transmitted to the other game apparatuses via the server or the like. Then, the processing proceeds to step S212.

In step S212, the processor 81 generates and outputs a game image. Then, the processing proceeds to step S213.

In step S213, the processor 81 determines whether or not an end condition for the first game (for example, a condition that a predetermined execution time (for example, 5 minutes) of the first game has elapsed) has been satisfied. If the determination result in step S213 is YES, the processing proceeds to step S3 in FIG. 17, and if the determination result in step S213 is NO, the processing returns to step S201.

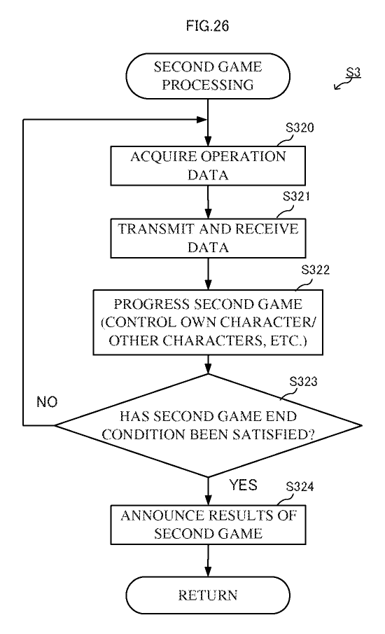

In step S3 in FIG. 17, the processor 81 performs the second game processing. As previously described, the second game is a game played with each character riding the machine that had been ridden by the character at the end of the first game (see FIG. 15), and the characters retain the items that had been acquired at the end of the first game. In addition, there are multiple types of second games, and each player participates in the type of second game selected after the end of the first game. FIG. 26 is an example of a flowchart of the second game processing.

In step S320 in FIG. 26, the processor 81 acquires the operation data 412. Then, the processing proceeds to step S321.

In step S321, the processor 81 transmits and receives data to and from the other game apparatuses of the multiplayer opponents. For example, the processor 81 transmits data indicating the current position (coordinates or the like) of the own character, the movement state of the own character, etc., to the other game apparatuses of the multiplayer opponents. In addition, the processor 81 receives data indicating the current positions (coordinates or the like) of the other characters, the movement states of the other characters, etc., from the other game apparatuses of the multiplayer opponents. Then, the processing proceeds to step S322.

In step S322, the processor 81 progresses the second game based on the operation data 412, the reception data 414, etc. For example, the processor 81 progresses the second game by controlling the own character based on operations performed by the player, and controlling the other characters based on operations performed by the other players who are the multiplayer opponents. Then, the processing proceeds to step S323.

In step S323, the processor 81 determines whether or not an end condition for the second game (for example, a condition that all characters have reached the goal in a race game) has been satisfied. If the determination result in step S323 is YES, the processing proceeds to step S324, and if the determination result in step S323 is NO, the processing returns to step S320.

In step S324, the processor 81 presents the result of the second game (such as a ranking or win/loss) (see FIG. 15(3)). The result of the second game may be regarded as the result of the competitive game. Then, the processing returns to FIG. 17, and the competitive game processing ends.

As described above, according to the exemplary embodiment, for example, in a scene in which the actual performance value of durability of an empty machine is small and the empty machine will be destroyed if attacked, guarding of the empty machine does not occur when no walking character is located near the empty machine (for example, within 5 m or 10 m), whereas guarding of the empty machine occurs when a walking character is located near the empty machine, thereby preventing the empty machine from being destroyed. Accordingly, the state of the empty machine (whether or not to perform guarding) can be changed according to the situation. In addition, it is possible to prevent a walking character from being hindered from boarding an empty machine and to support the walking character in boarding the empty machine.

Further, according to the exemplary embodiment, the own character can be caused to board an empty machine in a state where the machine is guarded against attacks by the empty machine guard. Therefore, even if a machine is attacked after the walking character has boarded the machine, it is possible to reduce the likelihood that the machine will be destroyed immediately.

Further, according to the exemplary embodiment, the empty machine guard makes it possible to guard against attacks that involve ramming with an empty machine to move the empty machine and thereby hinder a walking character from boarding the empty machine. Accordingly, it is possible to support a walking character in boarding an empty machine.

Further, according to the exemplary embodiment, an empty machine that has not been ridden by any character for a predetermined period (for example, 2 minutes) exits the stage. However, as described above, the empty machine is also guarded against ramming by the empty machine guard. Therefore, it is possible to prevent the empty machine from exiting the stage as a result of being repeatedly moved by ramming.

Further, according to the exemplary embodiment, the empty machine guard can be performed, for example, during a period from the start of the first game, which has an execution time of 5 minutes, until a predetermined time (for example, 2 minutes) has elapsed. Accordingly, it is possible to support a walking character in boarding an empty machine during an early stage of the first game in which acquisition of items is important.

Further, according to the exemplary embodiment, the empty machine guard is performed for characters having a small number of acquired items (see FIG. 13). Therefore, it is possible to support characters having a small number of acquired items and to suppress an increase in the difference in number of acquired items.

Further, according to the exemplary embodiment, the execution probability of empty machine guard is higher for characters having a smaller number of acquired items (see FIG. 13). Therefore, it is possible to support characters having a small number of acquired items and to suppress an increase in the difference in number of acquired items.

Further, according to the exemplary embodiment, it is possible to switch machines by causing the own character to temporarily dismount from a machine to transition to an on-foot state and then causing the own character to board another machine (see FIG. 8), or to switch to another machine without causing the own character to dismount from the machine (see FIG. 9).

Further, according to the exemplary embodiment, a walking character cannot acquire items, has a significantly lower movement speed than when riding a machine, and cannot destroy containers to cause items to appear. Therefore, by supporting a walking character in boarding a machine through the empty machine guard, it is possible to support acquisition of items.

Further, according to the exemplary embodiment, when the guidance condition is satisfied, an empty machine is guided and moved to a position close to a walking character. Therefore, it is possible to move the empty machine in accordance with the situation (see FIG. 14).

Further, according to the exemplary embodiment, a character that is in an on-foot state at the end of the first game boards a specific machine (typically, a machine whose machine characteristic values are generally lower than those of other machines) and participates in the second game. Accordingly, by performing the empty machine guidance to support a walking character in boarding a machine, it is possible to reduce the likelihood that a player will participate in the second game with a disadvantageous machine.

Further, according to the exemplary embodiment, the guidance condition is satisfied when the number of acquired items is relatively small (see FIG. 13). Accordingly, it is possible to guide an empty machine to and support a walking character having a relatively small number of acquired items.

Further, according to the exemplary embodiment, the guidance condition is satisfied when a predetermined time (empty machine guidance start waiting time; see FIG. 13) has elapsed after the character transitioned to an on-foot state. Accordingly, it is possible to prevent an empty machine from being immediately guided against the player’s intention. Further, according to the exemplary embodiment, the predetermined time (empty machine guidance start waiting time; see FIG. 13) is shorter for characters having a smaller number of acquired items. Accordingly, it is possible to promptly guide an empty machine to and support a walking character having a smaller number of acquired items.

Further, according to the exemplary embodiment, a guided empty machine is placed at a position within a predetermined range (for example, within 1 m) from the gaze point of the virtual camera. Accordingly, it is possible to cause the player to notice that the empty machine has been guided.

Further, according to the exemplary embodiment, an empty machine from which a character has dismounted and for which a predetermined time (for example, 20 seconds) has not elapsed after the machine became empty, is not guided. Accordingly, it is possible to prevent an empty machine immediately after a character dismounts therefrom from being guided against the player’s intention.

Further, according to the exemplary embodiment, an empty machine being guided is guarded and does not receive damage even if attacked. Accordingly, it is possible to reliably guide the empty machine. Further, according to the exemplary embodiment, the guided empty machine is placed at a position within a range in which the empty machine guard can be performed (for example, within 5 m from a walking character). Accordingly, the guided empty machine can be guarded by the empty machine guard.

Further, according to the exemplary embodiment, an empty machine within a predetermined period before exit (for example, a period in which the remaining time until exit is within 30 seconds) is not guided. Accordingly, it is possible to reduce the likelihood that an empty machine exits the stage while being guided.

Further, in the exemplary embodiment, a period during which an empty machine is being guided may be excluded from a period used to determine whether the empty machine exits the stage (that is, a period during which the empty machine is not ridden by any character (for example, 2 minutes)). In other words, the exit count for the empty machine may be stopped while the empty machine is being guided. Accordingly, it is possible to prevent an empty machine from exiting the stage while being guided.

Further, according to the exemplary embodiment, an empty machine whose actual performance value of durability (see FIG. 7) is equal to or less than a predetermined value (for example, 30% of the maximum value) is not guided. Therefore, it is possible to prevent an empty machine that is about to be destroyed from being guided.

Further, according to the exemplary embodiment, a walking character cannot acquire items, has a significantly lower movement speed than when riding a machine, and cannot destroy containers to cause items to appear. Therefore, by supporting a walking character in boarding a machine through the empty machine guidance, it is possible to support acquisition of items.

Further, according to the exemplary embodiment, items are also placed at positions to which a walking character cannot go (see FIG. 5). Therefore, by supporting a walking character in boarding a machine through the empty machine guidance, it is possible to support acquisition of items.

### Modifications

In the above-described exemplary embodiment, each machine may not necessarily be provided with a durability value, and a machine that has been attacked may be destroyed immediately.

Further, in the above-described exemplary embodiment, only a character that has destroyed an empty machine may be allowed to board this empty machine.

Further, in the above-described exemplary embodiment, as described with reference to FIG. 12, etc., if the guard occurrence condition is satisfied, instead of guarding an empty machine, attacks on the empty machine themselves may be disabled.

Further, in the above-described exemplary embodiment, at least one of the values of the handicap index, the guard‑enabling damage, and the empty machine guidance start waiting time (see FIG. 13) may decrease (or increase) linearly.

Further, in the above-described exemplary embodiment, the empty machine guard (see FIG. 12) and/or the empty machine guidance (see FIG. 14) may be able to be performed after the difference in number of acquired items between a character having the largest number of acquired items and a character having the smallest number of acquired items becomes equal to or greater than a predetermined value (for example, 10 or more; see FIG. 13).

Further, in the above-described exemplary embodiment, the empty machine guard (see FIG. 12) and/or the empty machine guidance (see FIG. 14) may not necessarily be performed until a predetermined time (for example, 30 seconds) has elapsed after the start of the first game.

Further, in the above-described exemplary embodiment, a machine that each character rides in the second game may be a machine of the same type as the machine that had been ridden by the character at the end of the first game, and in the second game, at least one of the machine characteristic values may be changed by a predetermined amount (for example, increased or decreased by 10%) compared with those in the first game.

Further, in the above-described exemplary embodiment, when guarding an empty machine (see FIG. 12), the empty machine may receive damage to a certain extent (for example, 30% of the damage that would otherwise be received).

Further, in the above-described exemplary embodiment, when a machine is attacked, instead of a method in which the actual performance value of durability of the machine is decreased (see FIG. 7), a method may be employed in which a destruction value that increases until the machine is destroyed is provided, and the machine is destroyed when the destruction value increases to a predetermined value.

Further, in the above-described exemplary embodiment, the execution time of the first game may be set by the player, and the length of a period during which the empty machine guard can be performed may be changed in accordance with the execution time of the first game. For example, when the execution time of the first game is set to 3 minutes, the period during which the empty machine guard can be performed may be set to 1 minute and 30 seconds, and, when the execution time of the first game is 7 minutes, the period during which the empty machine guard can be performed may be set to 4 minutes.

Further, in the above-described exemplary embodiment, a handicap index that is a fixed value associated with the number of acquired items (see FIG. 13) may be set. For example, the handicap index of a character whose number of acquired items is 15 may be set to 5 (fixed value), the handicap index of a character whose number of acquired items is 10 may be set to 8 (fixed value), and the handicap index of a character whose number of acquired items is 5 may be set to 12 (fixed value).

Further, in the above-described exemplary embodiment, the empty machine guidance may be performed only for a walking character that has the lowest rank in the number of acquired items or the like (see FIG. 13).

Further, in the above-described exemplary embodiment, a guided empty machine may be placed at a position in a direction in which a walking character is facing (that is, a position in front of the walking character).

Further, in the above-described exemplary embodiment, a character riding a machine may be allowed to switch to an empty machine being guided, by the method described with reference to FIG. 9.

Further, in the above-described exemplary embodiment, an empty machine that has not been ridden by any character for a predetermined time (for example, 2 minutes) may remain on the stage in a state where no character can board the empty machine, instead of exiting the stage.

Further, in the above-described exemplary embodiment, empty machines may appear on and disappear from the stage during the course of the first game.

In the first game, empty machines may not necessarily be placed in the stage, and a character may be caused to board a machine by collecting coins or machine parts placed in the stage and exchanging them for the machine.

A character that was not riding a machine at the end of the first game may start the second game in an on-foot state. Alternatively, a character that was not riding a machine at the end of the first game may be determined to be defeated in the competitive game, without participating in the second game.

The first game and/or the second game may be a team-based game.

In the first game, a rideable object not being ridden by any character may autonomously move around the stage. The rideable object may be, for example, an animal object such as a horse, a wolf, or a bird.

In the first game, each character may be unable to move while being in an on-foot state. In addition, when a machine being ridden by a character is destroyed, the character may automatically board an initial machine (machine a).

In the first game, each character riding a machine may be able to capture a machine being ridden by another character, or may be able to capture items acquired by another character.

Machines of the same type (having the same machine characteristic values) may have different appearances. For example, machines of the same type may have different colorings or shapes.

The riding-character correction and/or the acquired-item correction may include a correction that sets an actual performance value to be lower than a machine characteristic value.

In an information processing system including a terminal-side apparatus and a server-side apparatus capable of communicating therewith via a network, at least some of the series of processes described above may be executed by the server-side apparatus. The server may be composed of a plurality of information processing apparatuses, and the processes may be executed by the plurality of information processing apparatuses in a shared manner.

While the exemplary embodiments and modifications have been described above, it is to be understood that the above description is, in all aspects, merely an illustrative example, and is not intended to limit the scope thereof. In addition, it is to be understood that various improvements and changes can be made to the exemplary embodiments and modifications.

What is claimed is:

1. One or more non-transitory computer-readable storage media having stored therein instructions that, when executed, cause one or more processors to perform operations comprising:
executing a first multiplayer game in which a plurality of participating characters participate; and
in the first multiplayer game,
if a first condition that is not satisfied when a positional relationship between a first participating character and a rideable object not being ridden by any of the plurality of participating characters among a plurality of rideable objects placed in a first game stage is a first positional relationship and that is satisfied when the positional relationship is a second positional relationship closer than the first positional relationship is satisfied, causing the first participating character to board the rideable object,
causing the first participating character riding a rideable object to transition to a state of not riding the rideable object, in response to at least a first instruction based on an operation input,
if the first participating character is riding a rideable object, performing control of the first participating character, including at least movement in the first game stage, in response to a second instruction based on an operation input, based on a first in‑game parameter based on the rideable object being ridden by the first participating character,
if at least the first participating character is riding a rideable object and a second condition that is not satisfied when a positional relationship between the first participating character and an in-game item placed in the first game stage is a third positional relationship and that is satisfied when the positional relationship is a fourth positional relationship closer than the third positional relationship is satisfied, causing the first participating character to acquire the in-game item,
determining the first in‑game parameter corresponding to the rideable object being ridden by the first participating character, further based on the in-game item acquired by the first participating character, and
in a first scene, if a third instruction to cause a second participating character to attack a rideable object not being ridden by any of the plurality of participating characters is performed,
determining whether or not a third condition is satisfied, the third condition being satisfied when the first participating character not riding a rideable object does not exist at a position that satisfies the first condition with reference to a position of the rideable object,
if the third condition is satisfied, setting a state of the rideable object to a state in which at least the first participating character cannot board the rideable object, and
if the third condition is not satisfied, not setting the state of the rideable object to a state in which the first participating character cannot board the rideable object.

2. The one or more non-transitory computer-readable storage media according to claim 1, wherein the operations further comprise:
in response to a fourth instruction based on an operation input, sequentially executing the first multiplayer game and a second multiplayer game that is executed after end of the first multiplayer game; and
in the second multiplayer game,
causing the first participating character to board a rideable object of the same type as a type of rideable object ridden at the end of the first multiplayer game among a plurality of types of the rideable objects,
based on the type of a rideable object being ridden by the first participating character and the in-game item acquired by the first participating character at the end of the first multiplayer game, determining a second in-game parameter corresponding to the rideable object,
performing control of the first participating character riding the rideable object, including movement in a second game stage, in response to a fifth instruction based on an operation input, based on the second in-game parameter,
causing the plurality of participating characters to compete with each other, and
determining a win/loss or ranking of the plurality of participating characters in accordance with a result of the competition.

3. The one or more non-transitory computer-readable storage media according to claim 1, wherein
the operations further comprise, when the third instruction is performed with respect to the rideable object,
if the third condition is satisfied, updating a durability parameter indicating durability of the rideable object, by a first change amount, and
if the third condition is not satisfied, not updating the durability parameter or updating the durability parameter by a second change amount smaller than the first change amount, and
the first scene is a scene in which the durability parameter reaches a specified value when the third condition is satisfied.

4. The one or more non-transitory computer-readable storage media according to claim 3, wherein the operations further comprise:
if the third instruction is performed with respect to a rideable object being ridden by the first participating character, updating the durability parameter corresponding to the rideable object; and
if the durability parameter corresponding to the rideable object being ridden by the first participating character reaches the specified value, causing the first participating character to transition to a state of not riding the rideable object, and setting a state of the rideable object to a state in which at least the first participating character cannot board the rideable object.

5. The one or more non-transitory computer-readable storage media according to claim 1, wherein the operations further comprise, when the third instruction is performed with respect to the rideable object,
if the third condition is satisfied, moving the position of the rideable object, and
if the third condition is not satisfied, not moving the position of the rideable object.

6. The one or more non-transitory computer-readable storage media according to claim 5, wherein the operations further comprise setting a state of a rideable object that has not been ridden by any participating characters for a first period, to a state in which no participating character can board the rideable object.

7. The one or more non-transitory computer-readable storage media according to claim 2, wherein the third condition is further satisfied in a period after a second period has elapsed from start of the first multiplayer game.

8. The one or more non-transitory computer-readable storage media according to claim 1, wherein the third condition is not satisfied when a number of the in-game items acquired by the first participating character is smaller than a number of the in-game items acquired by another participating character.

9. The one or more non-transitory computer-readable storage media according to claim 1, wherein
the third condition is satisfied with a first probability, and
the first probability becomes lower as a number of the in-game items acquired by the first participating character becomes smaller relative to a number of the in-game items acquired by another participating character.

10. The one or more non-transitory computer-readable storage media according to claim 1, wherein the operations further comprise, if a positional relationship between a first rideable object not being ridden by any of the plurality of participating characters and the first participating character riding a second rideable object satisfies the first condition, causing the first participating character to board the first rideable object without causing the first participating character to transition to a state of not riding any of the first rideable object and the second rideable object.

11. The one or more non-transitory computer-readable storage media according to claim 1, wherein the operations further comprise, if the positional relationship between the first participating character and the in-game item satisfies the second condition and the first participating character is not riding a rideable object, not causing the first participating character to acquire the in-game item.

12. The one or more non-transitory computer-readable storage media according to claim 1, wherein the operations further comprise, in movement control of the first participating character in the first game stage, moving the first participating character riding a rideable object, at a higher movement speed than when the first participating character is not riding a rideable object.

13. The one or more non-transitory computer-readable storage media according to claim 1, wherein the operations further comprise, if the first participating character is riding a rideable object and the third instruction based on an operation input is performed with respect to a stage object placed in the first game stage, placing at least the in-game item acquirable by the first participating character, in the first game stage.

14. The one or more non-transitory computer-readable storage media according to claim 13, wherein the stage object includes a rideable object not being ridden by any of the plurality of participating characters.

15. The one or more non-transitory computer-readable storage media according to claim 1, wherein at least a part of the in-game items is placed at a position in the first game stage to which the participating character not riding a rideable object cannot move.

16. A game system comprising one or more processors and one or more non-transitory computer-readable storage media having stored therein instructions that, when executed, cause the one or more processors to perform operations comprising:
executing a first multiplayer game in which a plurality of participating characters participate; and
in the first multiplayer game,
if a first condition that is not satisfied when a positional relationship between a first participating character and a rideable object not being ridden by any of the plurality of participating characters among a plurality of rideable objects placed in a first game stage is a first positional relationship and that is satisfied when the positional relationship is a second positional relationship closer than the first positional relationship is satisfied, causing the first participating character to board the rideable object,
causing the first participating character riding a rideable object to transition to a state of not riding the rideable object, in response to at least a first instruction based on an operation input,
if the first participating character is riding a rideable object, performing control of the first participating character, including at least movement in the first game stage, in response to a second instruction based on an operation input, based on a first in‑game parameter based on the rideable object being ridden by the first participating character,
if at least the first participating character is riding a rideable object and a second condition that is not satisfied when a positional relationship between the first participating character and an in-game item placed in the first game stage is a third positional relationship and that is satisfied when the positional relationship is a fourth positional relationship closer than the third positional relationship is satisfied, causing the first participating character to acquire the in-game item,
determining the first in‑game parameter corresponding to the rideable object being ridden by the first participating character, further based on the in-game item acquired by the first participating character, and
in a first scene, if a third instruction to cause a second participating character to attack a rideable object not being ridden by any of the plurality of participating characters is performed,
determining whether or not a third condition is satisfied, the third condition being satisfied when the first participating character not riding a rideable object does not exist at a position that satisfies the first condition with reference to a position of the rideable object,
if the third condition is satisfied, setting a state of the rideable object to a state in which at least the first participating character cannot board the rideable object, and
if the third condition is not satisfied, not setting the state of the rideable object to a state in which the first participating character cannot board the rideable object.

17. A game apparatus comprising one or more processors and one or more non-transitory computer-readable storage media having stored therein instructions that, when executed, cause the one or more processors to perform operations comprising:
executing a first multiplayer game in which a plurality of participating characters participate; and
in the first multiplayer game,
if a first condition that is not satisfied when a positional relationship between a first participating character and a rideable object not being ridden by any of the plurality of participating characters among a plurality of rideable objects placed in a first game stage is a first positional relationship and that is satisfied when the positional relationship is a second positional relationship closer than the first positional relationship is satisfied, causing the first participating character to board the rideable object,
causing the first participating character riding a rideable object to transition to a state of not riding the rideable object, in response to at least a first instruction based on an operation input,
if the first participating character is riding a rideable object, performing control of the first participating character, including at least movement in the first game stage, in response to a second instruction based on an operation input, based on a first in‑game parameter based on the rideable object being ridden by the first participating character,
if at least the first participating character is riding a rideable object and a second condition that is not satisfied when a positional relationship between the first participating character and an in-game item placed in the first game stage is a third positional relationship and that is satisfied when the positional relationship is a fourth positional relationship closer than the third positional relationship is satisfied, causing the first participating character to acquire the in-game item,
determining the first in‑game parameter corresponding to the rideable object being ridden by the first participating character, further based on the in-game item acquired by the first participating character, and
in a first scene, if a third instruction to cause a second participating character to attack a rideable object not being ridden by any of the plurality of participating characters is performed,
determining whether or not a third condition is satisfied, the third condition being satisfied when the first participating character not riding a rideable object does not exist at a position that satisfies the first condition with reference to a position of the rideable object,
if the third condition is satisfied, setting a state of the rideable object to a state in which at least the first participating character cannot board the rideable object, and
if the third condition is not satisfied, not setting the state of the rideable object to a state in which the first participating character cannot board the rideable object.

18. A computer-implemented method comprising:
executing a first multiplayer game in which a plurality of participating characters participate; and
in the first multiplayer game,
if a first condition that is not satisfied when a positional relationship between a first participating character and a rideable object not being ridden by any of the plurality of participating characters among a plurality of rideable objects placed in a first game stage is a first positional relationship and that is satisfied when the positional relationship is a second positional relationship closer than the first positional relationship is satisfied, causing the first participating character to board the rideable object,
causing the first participating character riding a rideable object to transition to a state of not riding the rideable object, in response to at least a first instruction based on an operation input,
if the first participating character is riding a rideable object, performing control of the first participating character, including at least movement in the first game stage, in response to a second instruction based on an operation input, based on a first in‑game parameter based on the rideable object being ridden by the first participating character,
if at least the first participating character is riding a rideable object and a second condition that is not satisfied when a positional relationship between the first participating character and an in-game item placed in the first game stage is a third positional relationship and that is satisfied when the positional relationship is a fourth positional relationship closer than the third positional relationship is satisfied, causing the first participating character to acquire the in-game item,
determining the first in‑game parameter corresponding to the rideable object being ridden by the first participating character, further based on the in-game item acquired by the first participating character, and
in a first scene, if a third instruction to cause a second participating character to attack a rideable object not being ridden by any of the plurality of participating characters is performed,
determining whether or not a third condition is satisfied, the third condition being satisfied when the first participating character not riding a rideable object does not exist at a position that satisfies the first condition with reference to a position of the rideable object,
if the third condition is satisfied, setting a state of the rideable object to a state in which at least the first participating character cannot board the rideable object, and
if the third condition is not satisfied, not setting the state of the rideable object to a state in which the first participating character cannot board the rideable object.
